(19) United States
(12) Patent Application Publication
(10) Pub. No.: US 2026/0225206 A1
(43) Pub. Date: Aug. 6, 2026

(54) GRINDING TOOL

(71) Applicant: MILWAUKEE ELECTRIC TOOL CORPORATION, Brookfield, WI (US)

(72) Inventors: Joy A. Sodon, Wauwatosa, WI (US); Julia C. Marsh, Milwaukee, WI (US)

(21) Appl. No.: 19/466,930

(22) Filed: Feb. 2, 2026

Related U.S. Application Data
(60) Provisional application No. 63/754,820, filed on Feb. 6, 2025.
(60) Provisional application No. 63/867,149, filed on Aug. 20, 2025.
(60) Provisional application No. 63/898,041, filed on Oct. 13, 2025.

(51) Int. Cl. B24B 55/10; B25F 5/00; B25F 5/02

(52) U.S. Cl. CPC B24B 55/102; B25F 5/001; B25F 5/026

(57) ABSTRACT

A grinding tool includes an electric motor, a grinding disk that rotates about a grinding disk rotational axis, and a dust shroud assembly with an outer shroud including external threads and an inner shroud that is rotatable relative to the outer shroud. A rotatable adjustment ring includes a handle that allows a user to rotate the adjustment ring about an adjustment ring axis to adjust an axial position of the dust shroud assembly along the grinding disk rotational axis. The adjustment ring includes internal threads that mate with the external threads such that rotation of the adjustment ring results in axial movement of the dust shroud assembly along the grinding disk rotational axis. The adjustment ring includes a plurality of adjustment ring detent recesses positioned around an outside of the adjustment ring on an opposite and radially external side of the adjustment ring from the internal threads.

### CROSS-REFERENCE TO RELATED APPLICATIONS

The present application claims priority to U.S. Provisional Patent Application No. 63/898,041, filed on Oct. 13, 2025, U.S. Provisional Patent Application No. 63/867,149, filed on Aug. 20, 2025, and U.S. Provisional Patent Application No. 63/754,820, filed on Feb. 6, 2025, the entire contents of all of which are incorporated herein by reference.

### FIELD OF THE INVENTION

The present invention relates to power tools, and more particularly to powered grinding tools including dust shrouds and/or handles.

### BACKGROUND OF THE INVENTION

Dust shroud assemblies may capture and direct dust toward a desired location during use of a power tool. A user may desire to grip the power tool with one or more handles during use.

### SUMMARY OF THE INVENTION

The present invention provides, in one aspect, a grinding tool including a main body including a head portion. The grinding tool includes an electric motor. The grinding tool further includes an output shaft configured for transmitting torque received from the electric motor. The grinding tool further includes a grinding disk attached to the output shaft and configured for rotation therewith about a grinding disk rotational axis. The grinding tool further includes a dust shroud assembly at least partially surrounding the grinding disk. The dust shroud assembly includes an outer shroud and an inner shroud rotatable relative to the outer shroud. The grinding tool further includes a rotatable adjustment ring defining an adjustment ring axis. The adjustment ring includes a handle configured to allow a user to rotate the adjustment ring about the adjustment ring axis to adjust an axial position of the dust shroud assembly along the grinding disk rotational axis. The outer shroud includes an upstanding hub portion rotationally affixed to the head portion of the main body. The hub portion is at least partially configured as a cylinder defining a hub portion axis. The hub portion has external threads. The adjustment ring includes internal threads configured to mate with the external threads on the hub portion such that rotation of the adjustment ring results in axial movement of the dust shroud assembly along the grinding disk rotational axis. The adjustment ring includes a plurality of adjustment ring detent recesses positioned around an outside of the adjustment ring on an opposite and radially external side of the adjustment ring from the internal threads.

The present invention provides, in another aspect, a grinding tool including a main body including a head portion. The grinding tool includes an electric motor positioned within the main body and configured to transmit torque along a motor rotational axis. The grinding tool further includes a gearbox positioned at the head portion. The gearbox encloses a gear configured to receive torque from the electric motor and transmit the torque to an output shaft having a grinding disk attached thereto for rotation therewith. The grinding tool further includes a pommel handle at least partially enclosing the gearbox.

The present invention provides, in another aspect, a grinding tool including a main body including a head portion. The grinding tool includes an electric motor and an output shaft for transmitting torque received from the electric motor. The grinding tool includes a grinding disk attached to the output shaft for rotation therewith about a grinding disk rotational axis. The grinding tool includes a dust shroud assembly at least partially surrounding the grinding disk. The dust shroud assembly includes an outer shroud and an inner shroud that is rotatable relative to the outer shroud. The grinding tool includes a dust shroud latching assembly to selectively secure the inner shroud at a plurality of positions relative to the outer shroud. The dust shroud latching assembly includes a first magnet coupled to the outer shroud and a second magnet coupled to the inner shroud. The first magnet and the second magnet cooperate to hold the inner shroud and the outer shroud in a first relative position until changed by a user.

Other features and aspects of the invention will become apparent by consideration of the following detailed description and accompanying drawings.

### BRIEF DESCRIPTION OF THE DRAWINGS

FIG. 1 is an upper perspective view of a concrete grinder in accordance with an embodiment of the invention.

FIG. 2 is a side elevation view of the concrete grinder of FIG. 1.

FIG. 3 is another side elevation view of the concrete grinder of FIG. 1.

FIG. 4 is a plan view of the concrete grinder of FIG. 1.

FIG. 5 is a bottom view of the concrete grinder of FIG. 1.

FIG. 6 is a front side elevation view of the concrete grinder of FIG. 1.

FIG. 7 is a rear side elevation view of the concrete grinder of FIG. 1.

FIG. 8 is a cross-sectional view of the concrete grinder of FIG. 1 along section line 8-8 in FIG. 5.

FIG. 9 is a cross-sectional view of the concrete grinder of FIG. 1 along section line 9-9 in FIG. 5.

FIG. 10 is a first upper perspective view of an outer shroud of a dust shroud assembly of the concrete grinder of FIG. 1.

FIG. 11 is a plan view of the outer shroud of FIG. 10.

FIG. 12 is a bottom view of the outer shroud of FIG. 10.

FIG. 13 is a lower perspective view of the outer shroud of FIG. 10.

FIG. 14 is a second upper perspective view of the outer shroud of FIG. 10.

FIG. 15 is a first upper perspective view of an inner shroud of the dust shroud assembly of the concrete grinder of FIG. 1.

FIG. 16 is a second upper perspective view of the inner shroud of FIG. 15.

FIG. 17 is an upper perspective view of an adjustment ring of the concrete grinder of FIG. 1.

FIG. 18 is a plan view of the adjustment ring of FIG. 17.

FIG. 19 is a side elevation view of the adjustment ring of FIG. 17.

FIG. 20 is a cross-sectional view of the concrete grinder of FIG. 1 along section line 20-20 in FIG. 2.

FIG. 21 is a first upper perspective view of the concrete grinder of FIG. 1 with a pommel handle removed.

FIG. 22 is a second upper perspective view of the concrete grinder of FIG. 1 with the pommel handle removed.

FIG. 23 is a first perspective view of a concrete grinder in accordance with an embodiment of the invention.

FIG. 24 is a second perspective view of the concrete grinder of FIG. 23.

FIG. 25 is a bottom view of the concrete grinder of FIG. 23.

FIG. 26 is a perspective view of a dust shroud assembly and an adjustment ring of the concrete grinder of FIG. 23.

FIG. 26A is a cross-sectional view of the dust shroud assembly and the adjustment ring of FIG. 26 along section line 26A-26A of FIG. 26.

FIG. 27 is a bottom view of the dust shroud assembly of FIG. 26.

FIG. 28 is a bottom view of the dust shroud assembly of FIG. 26 with an annular retaining plate removed.

FIG. 29 is a perspective view of a pommel handle and a mounting flange of the concrete grinder of FIG. 23.

FIG. 30 is a front side elevation view of the mounting flange of FIG. 29.

FIG. 31 is a side elevation view of the mounting flange of FIG. 29.

FIG. 32 is a bottom view of the mounting flange of FIG. 29.

FIG. 33 is a plan view of the mounting flange of FIG. 29.

FIG. 33A is a perspective view of another embodiment of the mounting flange of FIG. 29.

FIG. 34 is a cutaway perspective view of the concrete grinder of FIG. 23.

FIG. 35 is another cutaway perspective view of the concrete grinder of FIG. 23.

FIG. 36 is a plan view of a ring gear of the concrete grinder of FIG. 23.

FIG. 37 is a bottom view of the concrete grinder of FIG. 23 with the dust shroud assembly and adjustment ring removed.

FIG. 38 is a lower perspective view of the concrete grinder of FIG. 23 with the dust shroud assembly and adjustment ring removed.

FIG. 39 is another cutaway perspective view of the concrete grinder of FIG. 23.

FIG. 40 is a bottom view of an outer shroud of the dust shroud assembly of FIG. 26.

FIG. 41 is a cross-sectional view of the outer shroud of FIG. 40 along section line 41-41 of FIG. 40.

FIG. 42 is a cross-sectional view of the outer shroud of FIG. 40 along section line 42-42 of FIG. 40.

FIG. 43 is a plan view of the outer shroud of FIG. 40.

FIG. 44 is a perspective view of the adjustment ring of FIG. 26.

FIG. 44A is a perspective view of another embodiment of the adjustment ring of FIG. 26.

FIG. 44B is another perspective view of the adjustment ring of FIG. 44A.

FIG. 44C is a bottom view of the adjustment ring of FIG. 44A.

FIG. 45 is a perspective view of an inner shroud of the dust shroud assembly of FIG. 26.

FIG. 46 is a perspective view of a first latching assembly for latching an inner shroud relative to an outer shroud of the dust shroud assembly of FIG. 26.

FIG. 47 is a cross-sectional view of the first latching assembly of FIG. 46 along section line 47-47 of FIG. 46.

FIG. 48 is a perspective view of a second latching assembly for latching an inner shroud relative to an outer shroud of the dust shroud assembly of FIG. 26.

FIG. 49 is a cross-sectional view of the second latching assembly of FIG. 48 along section line 49-49 of FIG. 48.

FIG. 50 is a perspective view of a third latching assembly for latching an inner shroud relative to an outer shroud of the dust shroud assembly of FIG. 26.

FIG. 51 is a cross-sectional view of the third latching assembly of FIG. 50 along section line 51-51 of FIG. 50.

FIG. 51A is a bottom view of a magnetic latching assembly for latching an inner shroud relative to an outer shroud of the dust shroud assembly of FIG. 26, showing the outer shroud.

FIG. 51B is a plan view of the outer shroud of FIG. 51A.

FIG. 51C is an upper perspective view of an inner shroud for use with the magnetic latching assembly of FIG. 51A.

FIG. 52 is a perspective view of a fourth latching assembly for latching an inner shroud relative to an outer shroud of the dust shroud assembly of FIG. 26.

FIG. 53 is a cross-sectional view of the fourth latching assembly of FIG. 52 along section line 53-53 of FIG. 52.

FIG. 54 is a cross-sectional view of a fifth latching assembly for latching an inner shroud relative to an outer shroud of the dust shroud assembly of FIG. 26.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

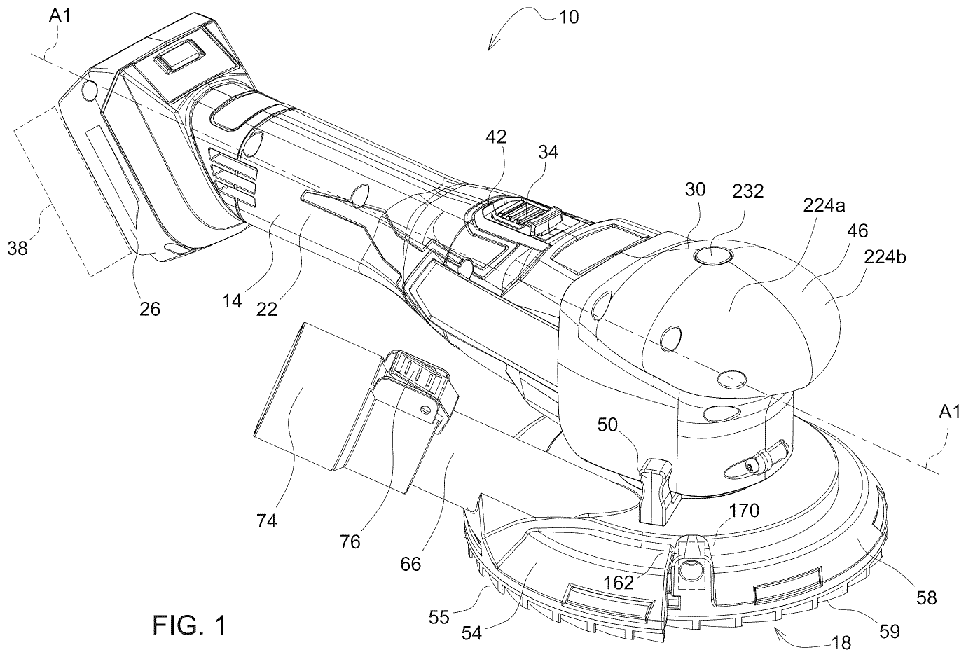

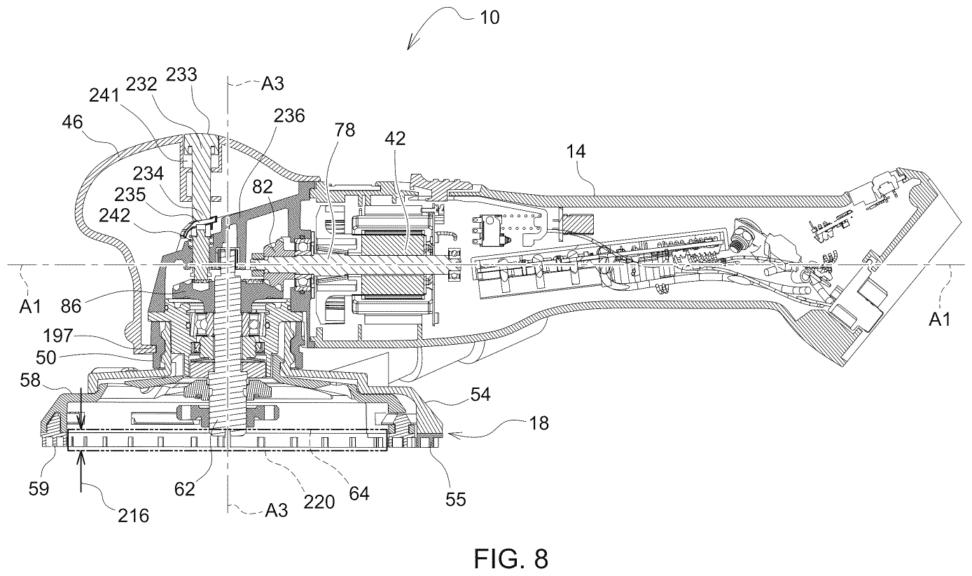

With reference to FIG. 1, a power tool 10 (e.g., a grinder such as a concrete grinder) includes a main body 14 and a dust shroud assembly 18. The main body 14 includes a handle portion 22, a battery pack receptacle 26 positioned at an end of the handle portion 22 distal from the dust shroud assembly 18, and a head portion 30 positioned at an end of the handle portion 22 proximal to the dust shroud assembly 18. The main body 14 includes a power switch 34 (e.g., a slide switch 34 or a paddle switch) to selectively activate and deactivate the power tool 10. The power tool 10 may be powered by a battery pack 38 (shown schematically in FIG. 1) that is received in the battery pack receptacle 26, and the battery pack 38 may be removable and usable with a variety of other power tools including drills, saws, etc. The battery pack 38 powers an electric motor 42 (shown schematically in FIG. 1 and shown in FIG. 8) that is positioned within the main body 14. The electric motor 42 delivers rotational torque along a motor axis A1, which generally extends along the handle portion 22. The head portion 30 of the handle portion 22 may include a pommel handle 46. An adjustment ring 50 is rotatable to adjust a position of the dust shroud assembly 18 relative to the head portion 30.

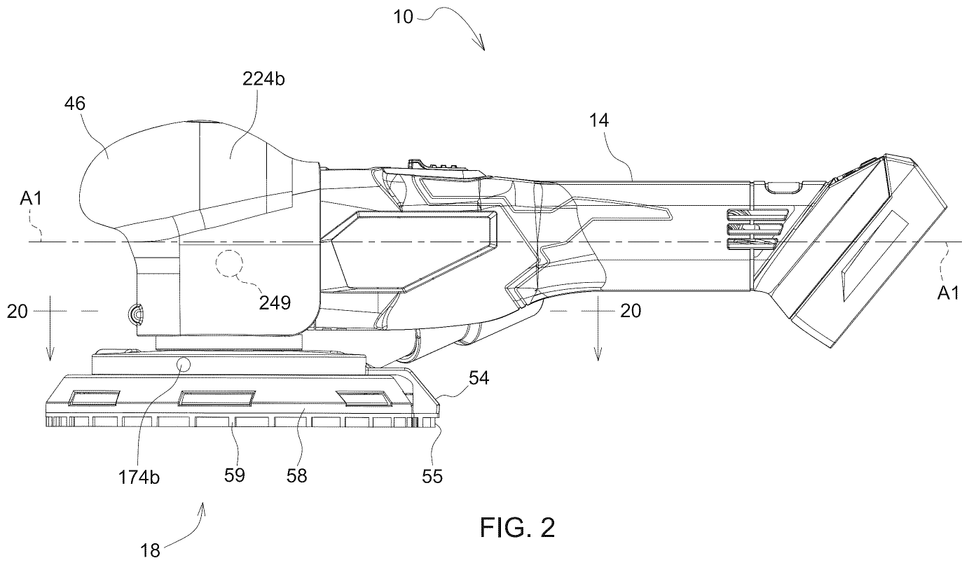

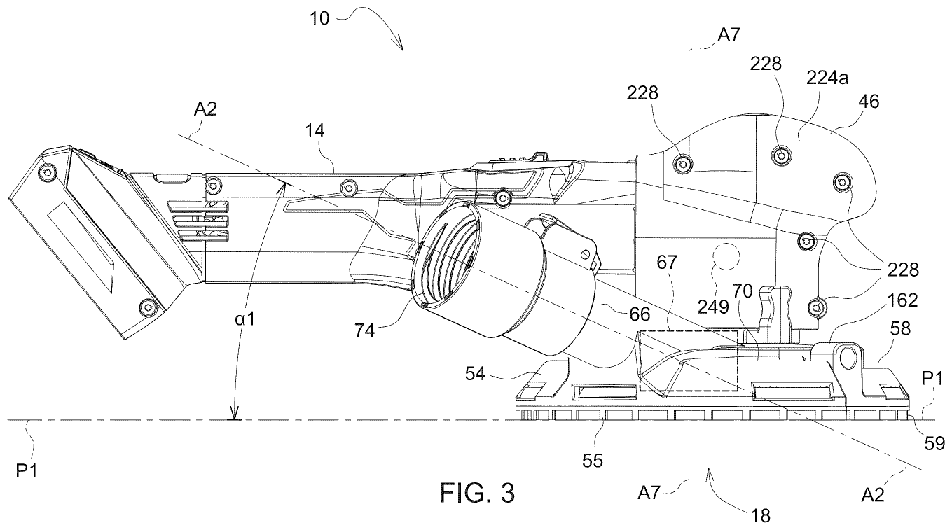

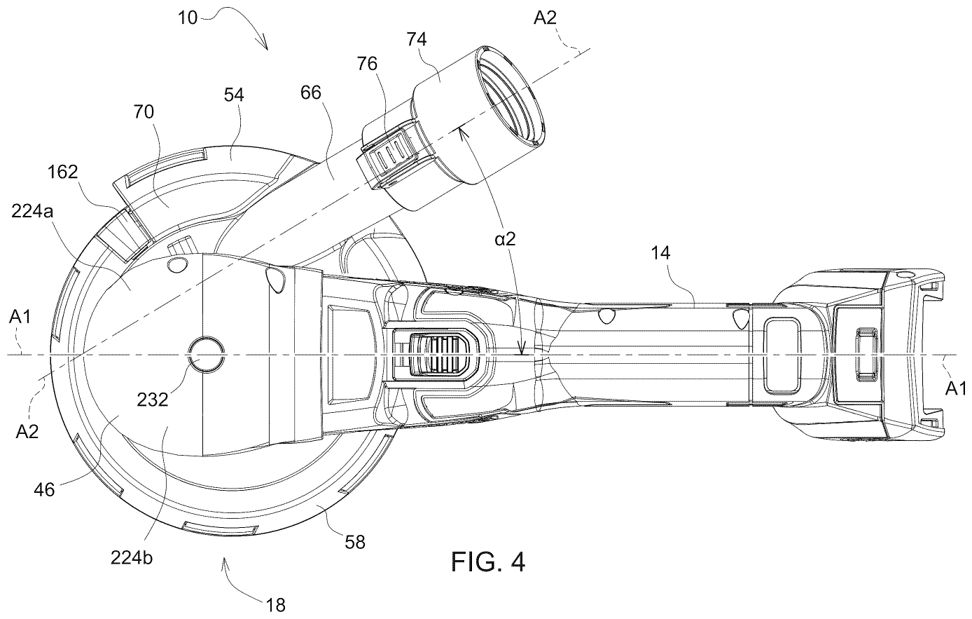

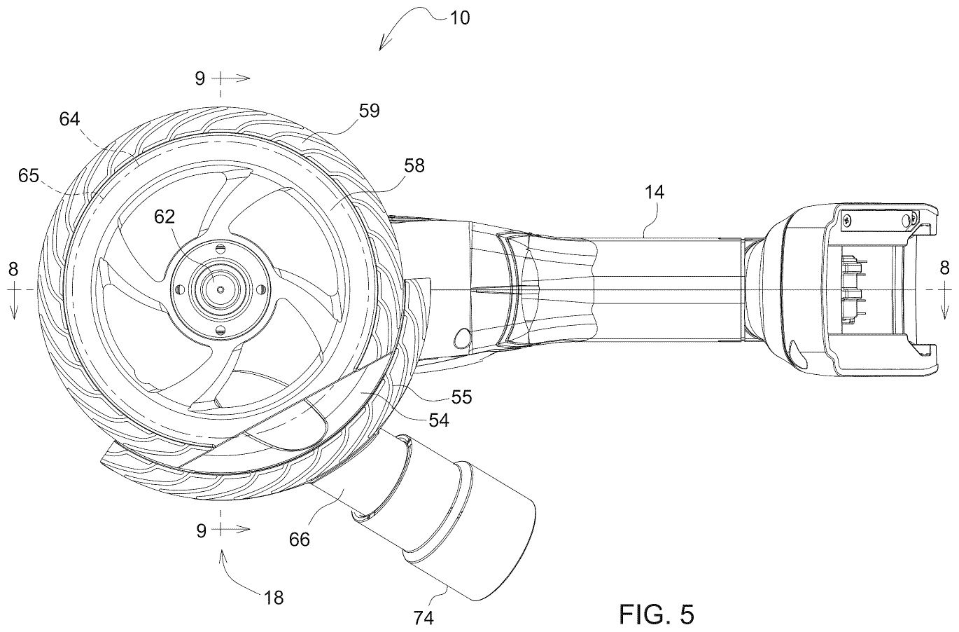

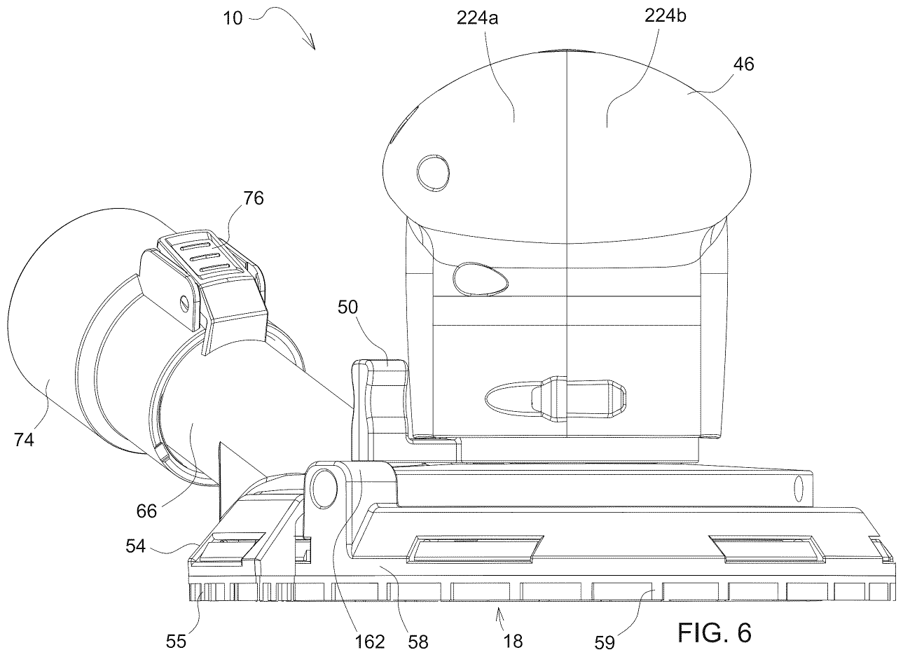

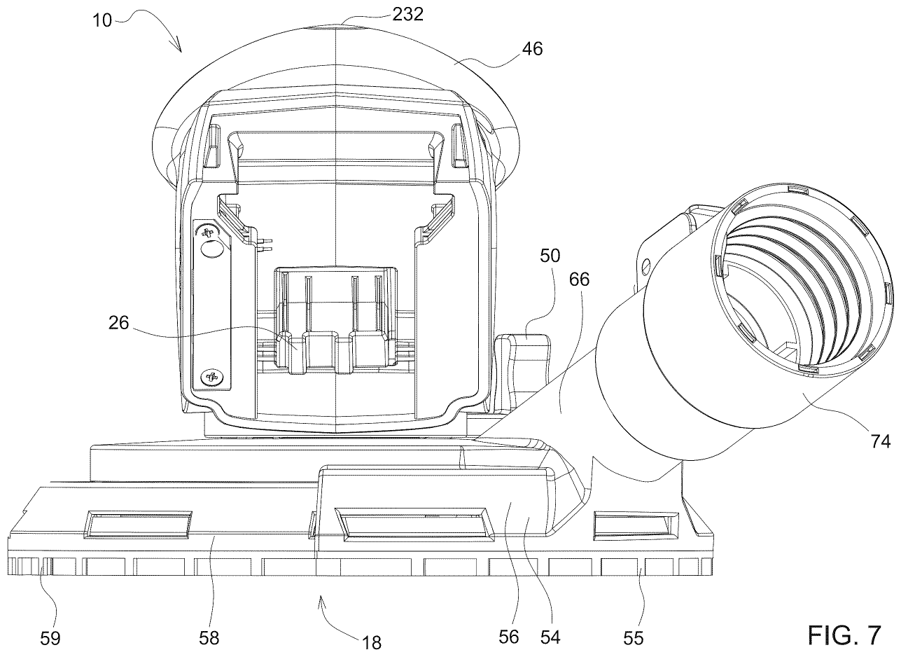

With reference to FIGS. 2-7, the dust shroud assembly 18 includes an outer shroud 54 and an inner shroud 58. The outer shroud 54 includes an outer seal 55, and the inner shroud 58 includes an inner seal 59. The outer seal 55 and the inner seal 59 may contact a surface to be worked (e.g., a surface to be ground, a surface to be sanded, etc.), form a seal against the surface to be worked, and inhibit airflow and dust flow between the seals 55, 59 and the surface to be worked. The shrouds 54, 58 at least partially surround an output shaft 62 and a working tool 64 (e.g., a concrete grinding disk or concrete polish disk shown schematically in FIG. 8), which may be mounted to the output shaft 62. The output shaft 62 transmits torque received from the electric motor 42. The working tool 64 defines a plane P1 (e.g., a working surface 220 of the working tool 64, shown schematically in FIG. 8, defines the plane P1 as shown in FIG. 3) when mounted to the output shaft 62. The working tool 64 includes an arclength 65 extending about a periphery of the working tool 64 (FIG. 5). In an embodiment in which the working tool 64 is a grinding disk, which is rotationally symmetrical about the working tool rotational axis A3, the arclength 65 of the working tool 64 is 360 degrees. The outer shroud 54 includes a dust extraction tube 66 extending from an upper side 70 of the outer shroud 54 (FIG. 4). In some embodiments, the dust extraction tube 66 may extend from a lateral sidewall 56 of the outer shroud 54 (FIG. 7). In some embodiments, the dust extraction tube 66 defines a dust extraction axis A2 extending at an angle α1 (e.g., at a nonzero acute angle α1 as shown in the illustrated embodiment) relative to the plane P1 measured in a direction perpendicular to the plane P1 (FIG. 3). In some embodiments, the dust extraction axis A2 extends at an angle α2 (e.g., at a nonzero acute angle as shown in the illustrated embodiment) relative to the motor axis A1 measured in a direction parallel to the plane P1 (FIG. 4). In some embodiments, the dust extraction tube 66 may be connected to the outer shroud 54 with a moveable joint 67 (e.g., a rotatable joint 67) such that the dust extraction tube 66 may rotate about a dust extraction tube rotational axis A7 (FIG. 3) to a desired angular position about the dust extraction tube rotational axis A7. In some embodiments, the dust extraction tube rotational axis A7 may be parallel to an output axis such as a working tool rotational axis A3 (described elsewhere herein). In operation, the dust extraction tube 66 may be rotated about the dust extraction tube rotational axis A7 to avoid contacting an object such as a user's hand or another aspect of the environment to obtain a desired position of the dust extraction axis A2. The dust extraction tube 66 terminates at an end that is couplable to a dust extraction port 74. The dust extraction port 74 is part of a dust extraction assembly such as a vacuum tube, a dust bag, or the like and is shown in the illustrated embodiment to show how the dust extraction port 74 may attach to the dust extraction tube 66. The dust extraction port 74 includes a latching actuator 76 that selectively connects the dust extraction port 74 to the dust extraction tube 66.

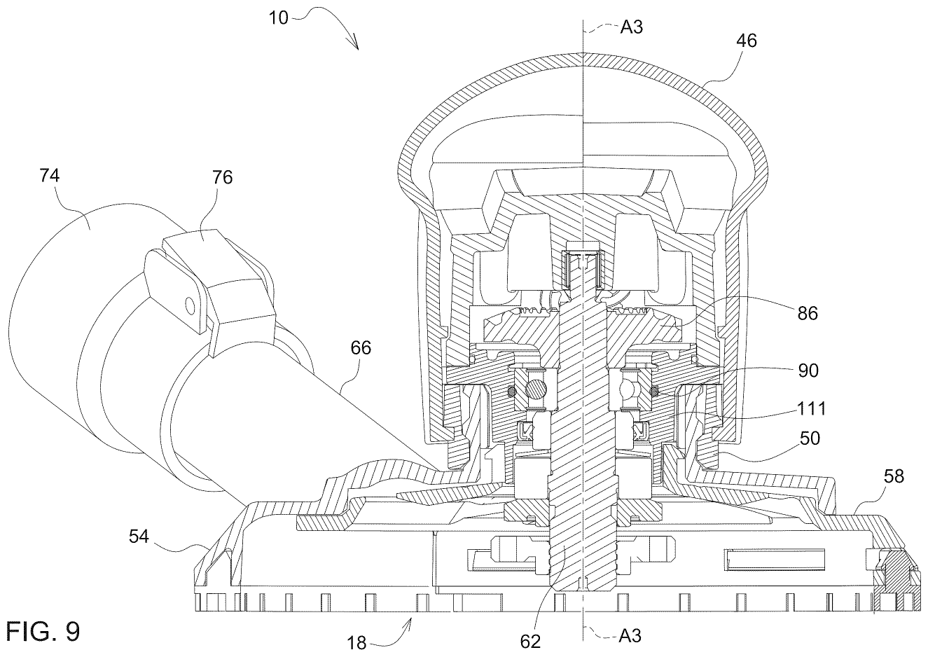

With reference to FIGS. 8 and 9, the output shaft 62 defines a working tool rotational axis A3 (e.g., a grinding disk rotational axis A3). The working tool rotational axis A3 may be, in some embodiments, parallel to the dust extraction tube rotational axis A7. In the illustrated embodiment, the working tool rotational axis A3 is perpendicular to the motor axis A1. The working tool 64 rotates about the working tool rotational axis A3. The electric motor 42 rotates a motor shaft 78, which is fixed to a pinion gear 82 for corotation therewith. The pinion gear 82 drives a ring gear 86, which is fixed to the output shaft 62 for corotation therewith. The output shaft 62 is rotatably supported by a bearing 90. The outer shroud 54 and the inner shroud 58 are, in the illustrated embodiment, centered about the working tool rotational axis A3. The inner shroud 58 is configured to pivot about the working tool rotational axis A3 relative to the outer shroud 54 between a closed position (e.g., a fully closed position) and an open position (e.g., a fully open position). The inner shroud 58 may pivot between multiple positions, including multiple open positions. In some embodiments, the inner shroud 58 may pivot between a fully open position and one or more partially open positions.

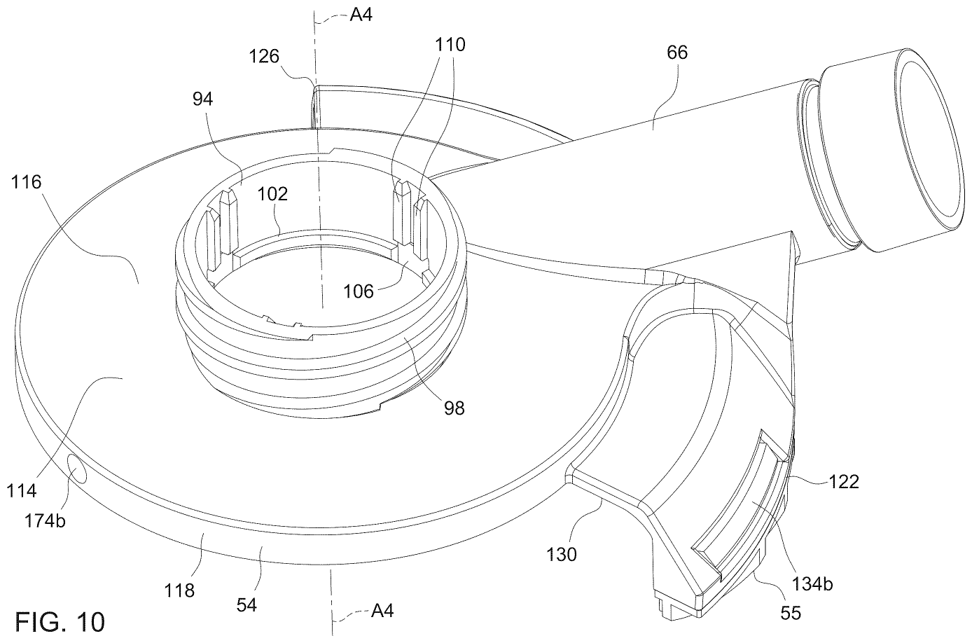

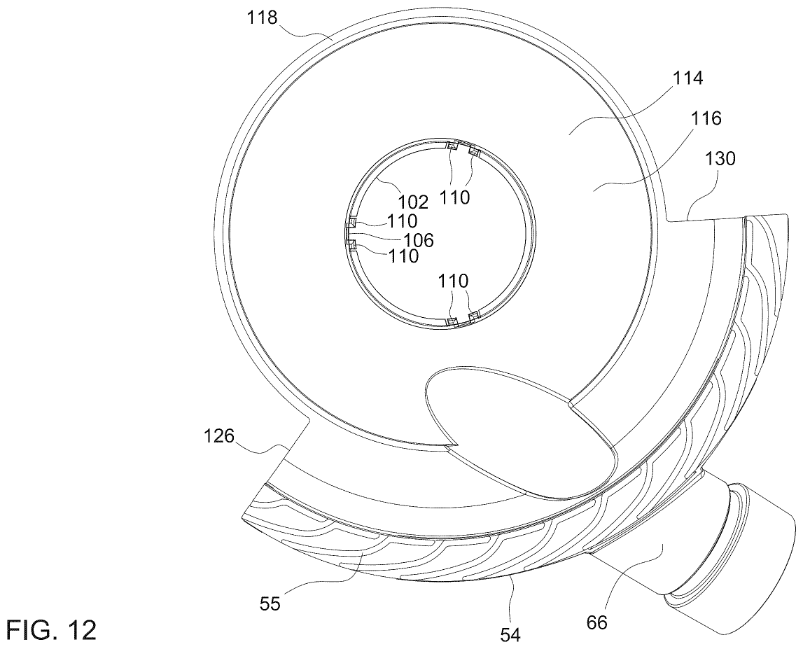

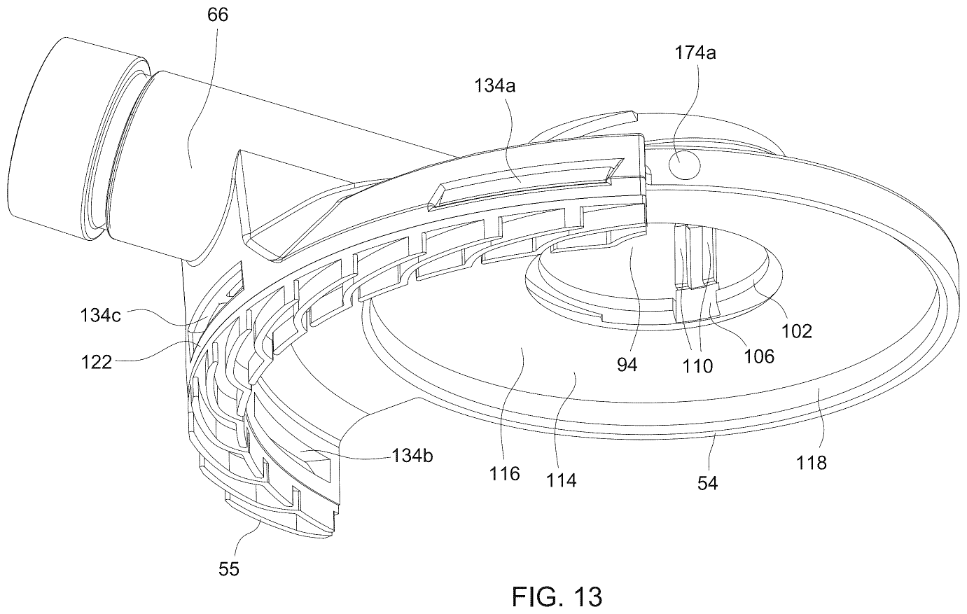

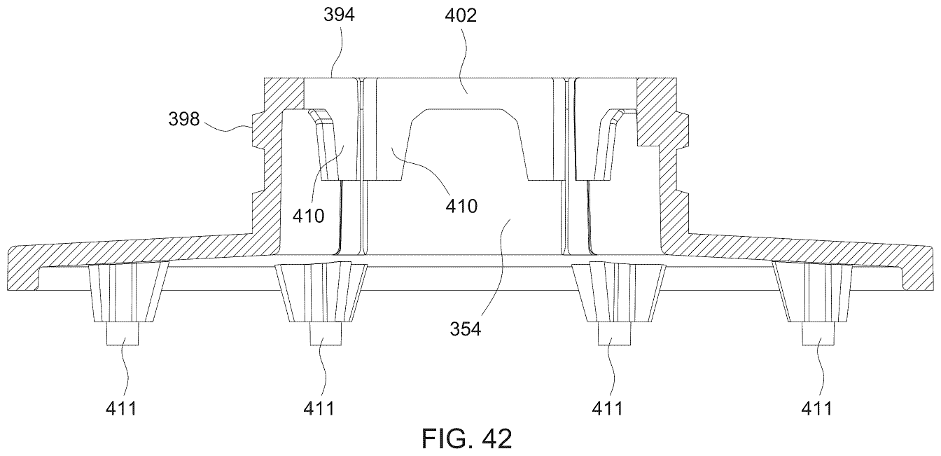

With reference to FIG. 10-14, the outer shroud 54 includes an upstanding outer hub portion 94 defining an outer shroud axis A4. When the outer shroud 54 is installed on the power tool 10, the outer shroud axis A4 may be collinear with the working tool rotational axis A3. The outer hub portion 94 is shaped as a cylinder having external threads 98. The outer hub portion 94 includes an inner circumferential protrusion 102 at a base of the outer hub portion 94. The inner circumferential protrusion 102 is interrupted by smooth portions 106 that are flush with a majority of a radially inner surface of the outer hub portion 94. The outer hub portion 94 includes pairs of inner axial protrusions 110. In the illustrated embodiment, each pair of inner axial protrusions 110 is positioned above one of the smooth portions 106. In some embodiments, the outer hub portion 94 may include inner axial protrusions 110 that are arranged individually such as the inner axial protrusions 410 of FIG. 42, rather than in pairs. The inner axial protrusions 110 may mate with a gearcase or gearcase cover 111 (FIG. 9) to rotationally position the outer shroud 54 with respect to the gearcase cover 111.

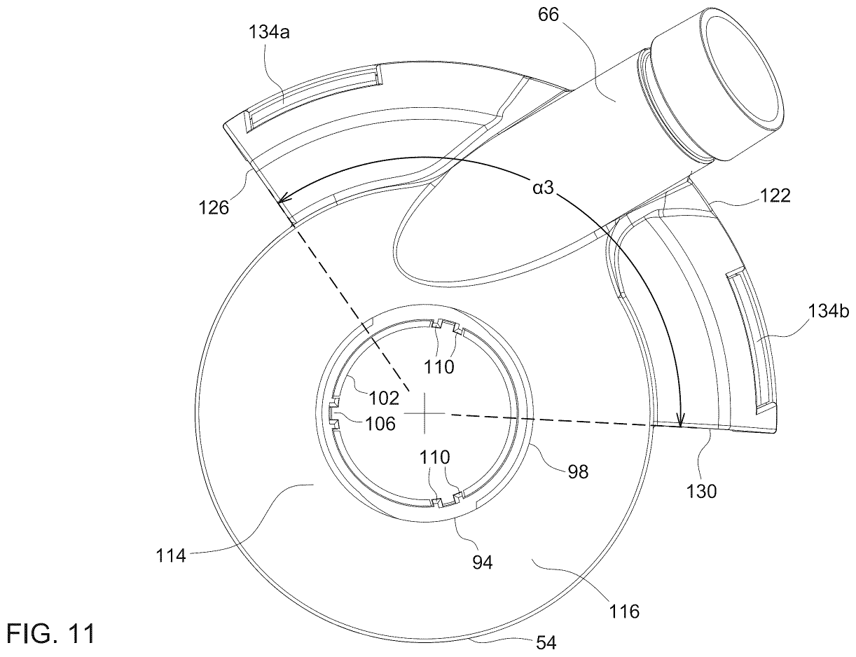

With continued reference to FIGS. 10-14, the outer shroud 54 includes a first arcuate wall portion 114 surrounding the outer hub portion 94. The arcuate wall portion 114 includes a horizontal segment 116 extending radially outward from the outer hub portion 94 relative to the rotational axis A3. A skirt 118 depends from the arcuate wall portion 114 and specifically from the horizontal segment 116 and may extend around more than 180 degrees of the arclength of the grinding disk 64. The dust extraction tube 66 extends obliquely from a top side of the arcuate wall portion 114. The outer shroud 54, and specifically the arcuate wall portion 114, further includes a vertical segment 122 extending radially relative to the outer shroud axis A4 from the horizontal segment 116. The vertical segment 122 extends circumferentially relative to the outer shroud axis A4 between a first endpoint 126 and a second endpoint 130 over an angle α3 (i.e., a guard extension angle) (FIG. 11). The angle α3 includes the dust extraction tube 66 between the endpoints 126, 130. In some embodiments, the angle α3 is less than 180 degrees, between 60 degrees and 150 degrees, between 80 degrees and 130 degrees, between 90 degrees and 120 degrees, about 90 degrees, or about 120 degrees. In some embodiments, the angle α3 may be greater than 180 degrees, such as between 180 degrees and 270 degrees, between 270 degrees and 360 degrees, or between 225 degrees and 315 degrees, and may be 360 degrees. In some embodiments, the angle α3 may be between 180 degrees and 360 degrees, between 180 degrees and 330 degrees, between 180 degrees and 300 degrees, between 180 degrees and 270 degrees, between 180 degrees and 240 degrees, or between 180 degrees and 210 degrees. The vertical segment 122 extends radially beyond a radially outer edge of the horizontal segment 116. The vertical segment 122 includes one or more recesses 134a, 134b, 134c for attaching to and supporting a seal. In the illustrated embodiment, the vertical segment 122 includes three rectangular circumferentially-oriented recesses 134a, 134b, 134c that receive and support the outer seal 55.

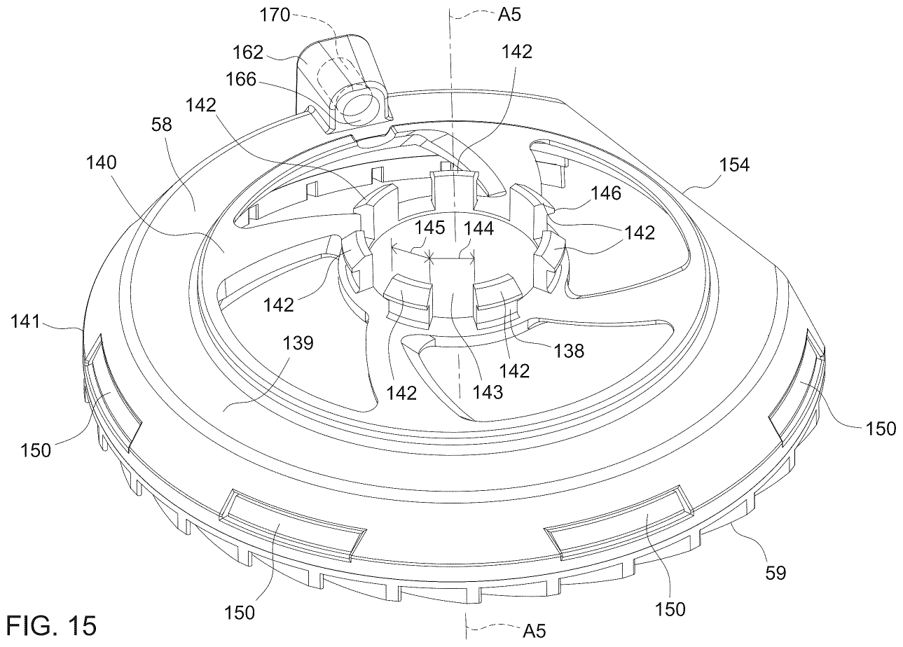

With reference to FIG. 15, the inner shroud 58 includes an upstanding inner hub portion 138 at least partially arranged as a cylinder defining an inner shroud axis A5. When the inner shroud 58 is installed on the power tool 10, the inner shroud axis A5 may be collinear with the working tool rotational axis A3 and/or with the outer shroud axis A4. The inner hub portion 138 includes a second arcuate wall portion 139 having a horizontal segment 140 extending radially outward from the inner hub portion 138 relative to the rotational axis A3. The second arcuate wall portion 139 further includes a vertical segment 141 circumferentially extending around more than 180 degrees of the arclength of the grinding disk 64. In some embodiments, the vertical segment 141 may circumferentially extend around less than 180 degrees of the arclength of the grinding disk 64. The inner hub portion 138 includes a plurality of circumferentially-spaced upstanding projections 142. In the illustrated embodiment, the inner hub portion 138 includes seven upstanding projections 142. Each upstanding projection 142 includes a hook 146. The hook 146 is oriented radially outwardly relative to the inner shroud axis A5. The inner hub portion 138 fits within the outer hub portion 94 to attach the outer shroud 54 to the inner shroud 58. The hooks 146 engage with the inner circumferential protrusion 102 of the outer hub portion 94 to inhibit axial removal of the inner shroud 58 from the outer shroud 54 (i.e., to inhibit separation of the inner shroud 58 from the outer shroud 54). In certain rotational orientations of the inner shroud 58 relative to the outer shroud 54, one or more of the hooks 146 engage with the inner axial protrusions 110 to inhibit movement of the inner shroud 58 toward the outer shroud 54. For example, when the inner shroud 58 is positioned in the fully open position, and also when the inner shroud 58 is positioned in the fully closed position, the inner axial protrusions 110 engage with the hooks 146 to inhibit movement of the inner shroud 58 toward the outer shroud 54.

With continued reference to FIG. 15, gaps 143 between adjacent upstanding projections 142 may span a first proportion 144 of an arclength 65 of the working tool 64. Each of the upstanding projections 142 spans a second proportion 145 of the arclength 65 of the working tool 64. The first proportion 144 of the arclength 65 of the working tool 64 may be approximately equal to the second proportion 145 of the arclength 65 of the working tool 64. In some embodiments, the first proportion 144 of the arclength 65 may be within 30% of the second proportion 145 of the arclength 65 (i.e., the first proportion 144 of the arclength 65 may be less than or equal to 30% greater than the second proportion 145 of the arclength 65, or the first proportion 144 of the arclength 65 may be less than or equal to 30% less than the second proportion 145 of the arclength 65). In some embodiments, the first proportion 144 of the arclength 65 may be within 10%, within 15%, within 20%, within 25%, within 35%, within 40%, within 45%, or within 50% of the second proportion 145 of the arclength 65.

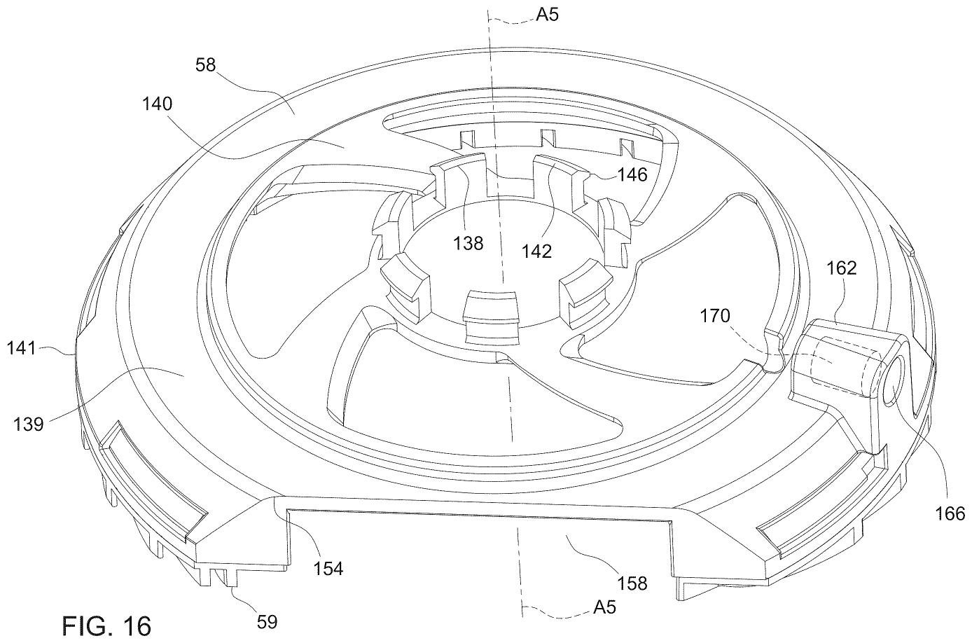

With reference to FIGS. 15 and 16, the inner shroud 58 includes a plurality of recesses 150 for attaching to and supporting a seal. In the illustrated embodiment, the recesses 150 are rectangularly shaped and are peripherally spaced about the inner shroud 58 to support the inner seal 59. An outer periphery of the inner shroud 58 generally defines a circle in a field of view in a direction parallel to the inner shroud axis A5, except that one portion of the circle is removed (i.e., not present). In the illustrated embodiment, the portion of the circle that is removed (i.e., not present) is a segment. Geometrically, a segment is a portion of a circle that is “cut off” from the rest of the circle by a straight line known as a “chord.” In the illustrated embodiment, a chord 154 defines a portion of the outer periphery of the inner shroud 58. The chord 154 includes a radial dust passage 158. The chord 154 may be defined by an absence of the vertical segment 141. In some embodiments, the vertical segment 141 may extend around more than 180 degrees of the arclength of the grinding disk 64, and the chord 154 may be defined by an absence of the vertical segment 141 around a balance of the arclength of the grinding disk 64.

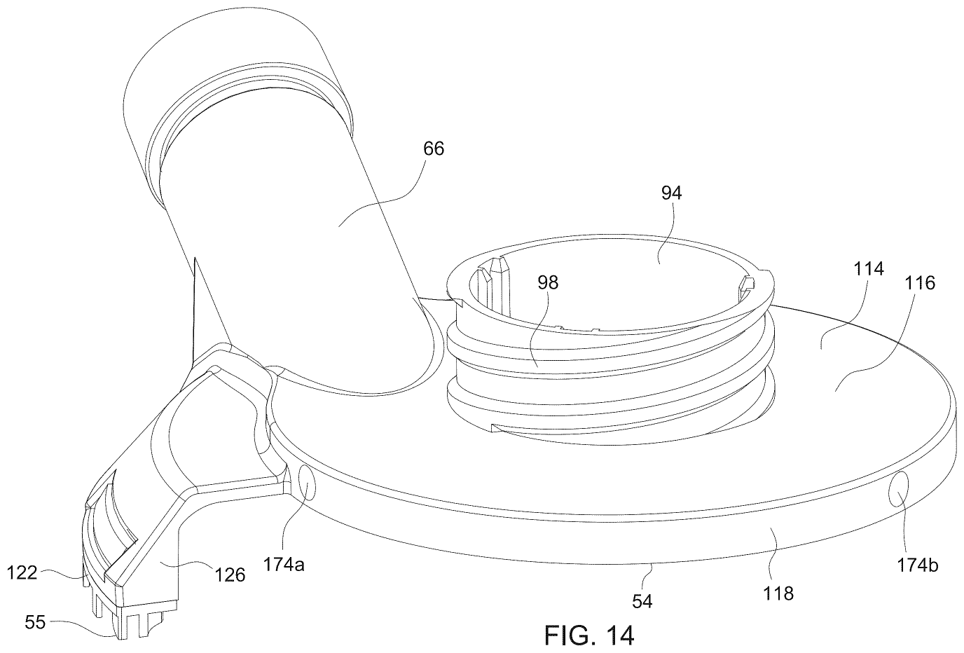

With reference to FIGS. 14-16, the inner shroud 58 includes a hand grip 162 in the form of an upstanding projection that also extends radially relative to the inner shroud axis A5. The hand grip 162 includes a bore 166 therein for receiving a detent 170 such as a spring-loaded ball detent (shown schematically in FIGS. 15 and 16) or a pin detent. The detent 170 engages with outer shroud detent recesses 174a, 174b (i.e., first and second outer shroud detent recesses 174a, 174b) in an outer periphery of the skirt 118 of the outer shroud 54. In some embodiments, the outer shroud 54 may include the detent 170. In some embodiments, neither the inner shroud 58 nor the outer shroud 54 includes the detent 170. For example, the power tool 10 may not include the detent 170 and may not include the detent recesses 174a, 174b. In some embodiments, mechanisms for selectively locking a position of the inner shroud 58 relative to the outer shroud 54 may include a sliding lock or latch, a button assembly, a magnet, etc.

In operation, and with reference to FIGS. 1-6, the inner shroud 58 is pivotable about the inner shroud axis A5 relative to the outer shroud 54 between a closed position in which the detent 170 is received in the recess 174a and an open position in which the detent 170 is received in the recess 174b. In the closed position, the chord 154 of the inner shroud 58 is covered by the vertical segment 122 of the outer shroud 54 such that an airflow path extends through the dust passage 158 and through the dust extraction tube 66 to carry dust away from the working tool 64 (the working tool 64 being shown schematically in FIG. 8). In some embodiments, in a closed position such as a fully closed position, an entirety of an arclength of the working tool 64 (e.g., the grinding disk 64) is covered by a combination of the inner shroud 58 and the outer shroud 54. In the open position, the chord 154 is not covered by the vertical segment 122 of the outer shroud 54. In the open position, dust is ejected through the dust passage 158 without passing through the dust extraction tube 66. In some embodiments, in an open position, a portion of the arclength of the working tool 64 (e.g., the grinding disk 64) may be exposed from the dust shroud assembly 18.

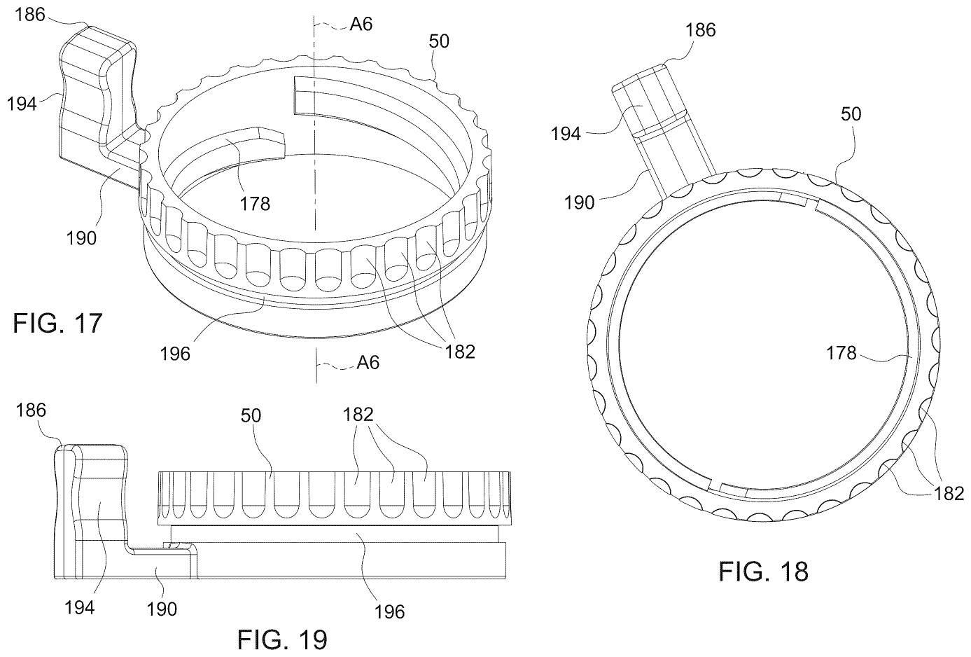

With reference to FIGS. 17-19, the adjustment ring 50 may be shaped as a cylinder defining an adjustment ring axis A6 and includes internal threads 178. The internal threads 178 are sized and shaped to mate with the external threads 98 on the outer hub portion 94 on the outer shroud 54 such that rotation of the adjustment ring 50 results in axial movement of the outer shroud 54 along the outer shroud axis A4, the inner shroud axis A5, and the adjustment ring axis A6, which are coaxial. The adjustment ring 50 includes a plurality of detent recesses 182 positioned around an outside of the adjustment ring 50 (i.e., on an opposite and radially external side of the adjustment ring 50 from the internal threads 178). The detent recesses 182 are spaced evenly around the adjustment ring 50 corresponding to equal height adjustment intervals for the dust shroud assembly 18. In some embodiments, the detent recesses 182 may be unevenly spaced around the adjustment ring 50, corresponding to unequal height adjustment intervals for the dust shroud assembly 18. In the illustrated embodiment, the adjustment ring includes 31 detent recesses 182, each detent recess spaced approximately between 5 and 15 degrees apart, between 10 and 12 degrees apart, or about 11.6 degrees apart. The adjustment ring 50 includes a handle 186 for allowing a user to pivot the adjustment ring 50 about the adjustment ring axis A6. The handle 186 includes a radial protrusion 190 that extends radially relative to the adjustment ring axis A6. The handle 186 further includes an axial handgrip portion 194 that extends from the radial protrusion 190 axially relative to the adjustment ring axis A6. The adjustment ring 50 includes a circumferential external groove 196 extending around the adjustment ring 50. In some embodiments, the external groove 196 may extend 360 degrees about the adjustment ring 50. In some embodiments, the external groove 196 may extend less than 360 degrees about the adjustment ring 50. For example, a tab may interrupt the external groove 196 such that the external groove 196 extends less than 360 degrees about the adjustment ring 50. An interruption in the external groove 196 (such as a tab) may serve as a hard stop to limit a range of height adjustment permitted by the adjustment ring 50. The external groove 196 may have a rectangular cross section and, in some embodiments, may have a square cross section. The external groove 196 is axially positioned with respect to the adjustment ring axis A6 between the radial protrusion 190 and the plurality of detent recesses 182. The external groove 196 receives a projection 197 extending from a component of the power tool 10 that is fixed with respect to the main body 14. In the illustrated embodiment, the projection 197 extends from the pommel handle 46 and axially fixes the position of the adjustment ring 50 and the position of the pommel handle 46 with respect to each other along the working tool rotational axis A3 (FIG. 8).

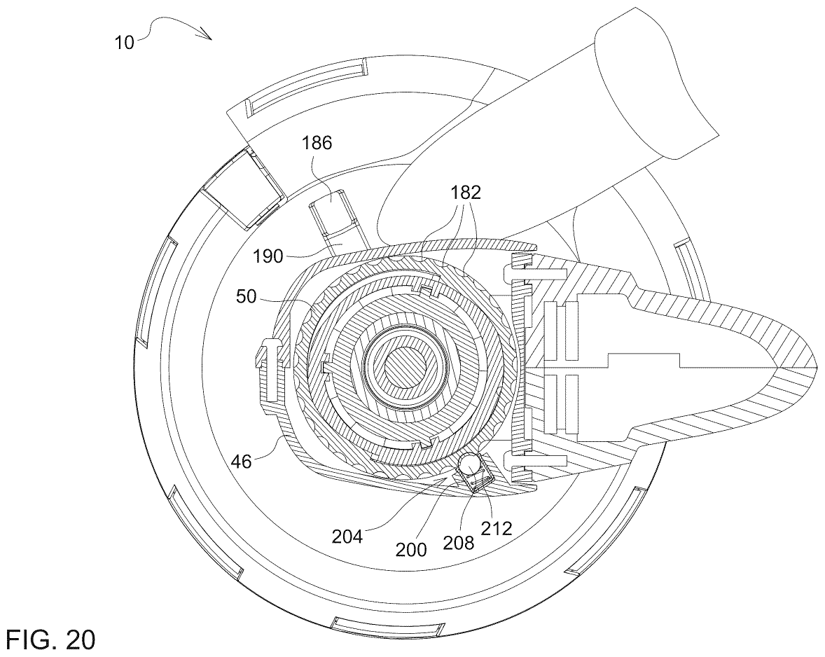

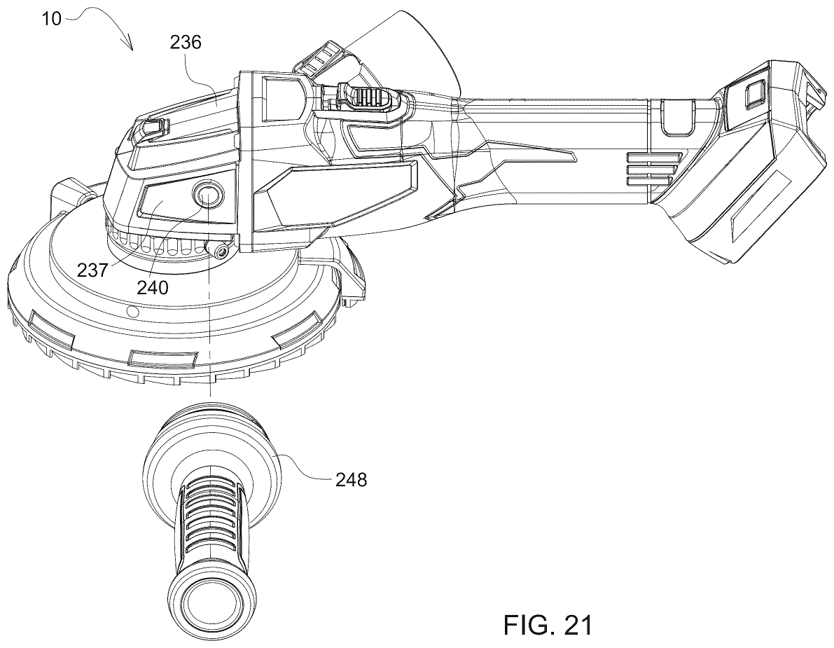

With reference to FIG. 20, the pommel handle 46 includes a recess 200 that houses a detent mechanism 204. In the illustrated embodiment, the detent mechanism 204 includes a detent 208 such as a detent ball 208 or, in some embodiments, a detent pin. The detent mechanism 204 also includes a detent spring 212. The detent spring 212 biases the detent ball 208 into one of the detent recesses 182 that are spaced around the adjustment ring 50. Pivoting the adjustment ring 50 by rotating the handle 186 about the working tool rotational axis A3, the outer shroud axis A4, the inner shroud axis A5, and/or the adjustment ring axis A6 selects the particular detent recess 182 into which the detent spring 212 biases the detent ball 208. The particular detent recess 182 into which the detent ball 208 is biased is determined by a rotational position of the adjustment ring 50 relative to the detent mechanism 204 about the working tool rotational axis A3, the outer shroud axis A4, the inner shroud axis A5, and/or the adjustment ring axis A6.

In operation, and with reference to FIGS. 1, 8, 9, and 20, rotating the adjustment ring 50 about the working tool rotational axis A3, the outer shroud axis A4, the inner shroud axis A5, and/or the adjustment ring axis A6 results in axial movement of the external threads 98 on the outer shroud 54 with respect to the internal threads 178 on the adjustment ring 50. From the frame of reference of FIG. 20 (i.e., a direction facing along the working tool rotational axis A3 in a direction of power output), rotating the adjustment ring 50 clockwise causes the dust shroud assembly 18 to move upwards and toward the head portion 30 of the power tool 10. From the frame of reference of FIG. 20, rotating the adjustment ring 50 counterclockwise causes the dust shroud assembly 18 to move downwards and away from the head portion 30 of the power tool 10. In some embodiments, the external threads 98 on the outer shroud 54 and the internal threads 178 on the adjustment ring 50 may be oriented such that rotating the adjustment ring 50 counterclockwise causes the dust shroud assembly 18 to move upwards and toward the head portion 30 of the power tool 10 and vice versa.

In operation, and with continued reference to FIGS. 1, 8, 9, and 20, the working tool 64 may wear during use, resulting in a thickness 216 (shown in FIG. 8) of the working tool 64 becoming smaller. As the thickness 216 of the working tool 64 shrinks during use of the power tool 10, a rotational position of the adjustment ring 50 may be periodically adjusted to adjust an axial position of the dust shroud assembly 18 along the working tool rotational axis A3 to compensate for the change in thickness 216 of the working tool 64 so that the dust shroud assembly 18 is maintained at a desired axial position relative to a working surface 220 of the working tool 64.

With reference to FIGS. 1-4, 6, and 8, the pommel handle 46 includes clamshell halves 224a, 224b. The clamshell halves 224a, 224b are affixed to each other with fasteners 228 (e.g., screws) (FIG. 3). A spindle lock actuator 232 extends through a top surface of the pommel handle 46 and in the illustrated embodiment extends through a top surface of both clamshell halves 224a, 224b such that the spindle lock actuator 232 is surrounded on a first side by the clamshell half 224a and on a second side by the clamshell half 224b (FIG. 4). The spindle lock actuator 232 includes a first user-actuatable end 233 positioned at a top of the pommel handle 46 and an opposite, second end 234 abutting a spindle lock pin 235 within an interior of the pommel handle 46 and slidably supported within a gearbox 236. In some embodiments, the spindle lock actuator 232 may be biased upwards (e.g., away from the gearbox 236 and/or away from the ring gear 86 and the output shaft 62) by a first spring 241, and the spindle lock pin 235 may also be biased in the same direction by a second spring 242. The spindle lock pin 235 receives linear motion from the spindle lock actuator 232 to selectively lock the ring gear 86 and the output shaft 62 from rotating. In other words, to lock rotation of the ring gear 86 and therefore the output shaft 62, a user depresses the spindle lock actuator 232 against the bias of the first spring 241, pushing the spindle lock actuator 232 into the pommel handle 46. Because the second end 234 of the spindle lock actuator 232 is in contact with the spindle lock pin 235, the spindle lock pin 235 is also depressed in the same direction against the bias of the second spring 242 to engage a corresponding recess in the ring gear 86, thereby locking rotation of the output shaft 62 so that a first working tool 64 may be exchanged with a second working tool. In some embodiments, the spindle lock pin 235 and the spindle lock actuator 232 may be integrally formed together as a single part such that the spindle lock actuator 232 is directly connected to the gearbox 236 and extends through the pommel handle 46. In some embodiments, such as in some embodiments in which the spindle lock pin 235 and the spindle lock actuator 232 are integrally formed as a single part, only one of the springs 241, 242 may be included.

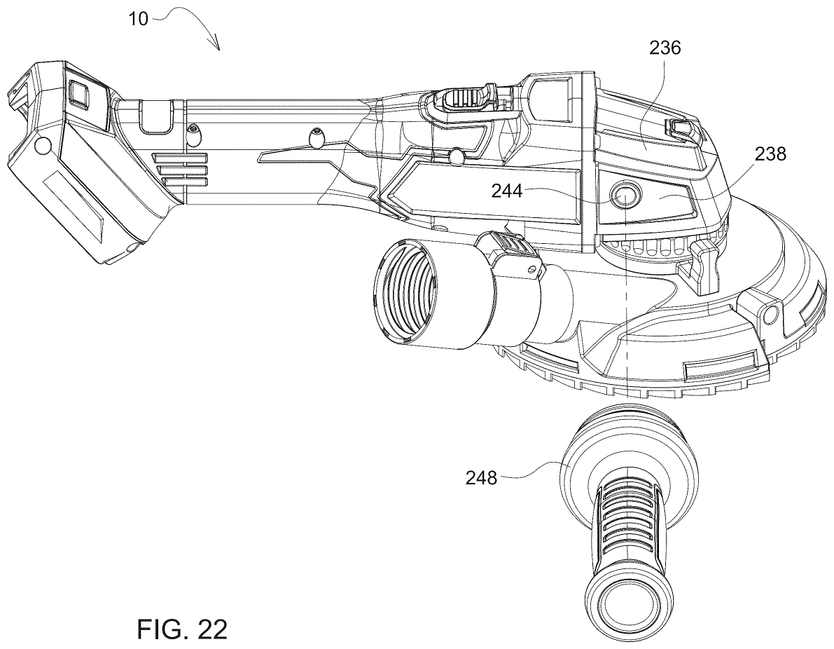

With reference to FIGS. 21 and 22, the power tool 10 is illustrated with the pommel handle 46 hidden to reveal the gearbox 236. In operation, the pommel handle 46 covers the gearbox 236. The gearbox 236 encloses (i.e., houses) the pinion gear 82 and the ring gear 86 (FIG. 8). The gearbox 236 may include a first attachment recess 240 (FIG. 21) on a first side 237 of the gearbox 236 and a second attachment recess 244 (FIG. 22) on a second side 238 of the gearbox 236. The first side 237 may be opposite the second side 238. The attachment recesses 240, 244 may be, for example, threaded bores. The attachment recesses 240, 244 are each configured to receive a portion of a handle 248 for attaching the handle 248 (shown schematically in FIGS. 21 and 22) to one of the attachment recesses 240, 244 (e.g., each attachment recess 240, 244 may be threaded to receive a threaded portion of the handle 248). The handle 248 may attach to the gearbox 236 in an orientation transverse to, and in some embodiments perpendicular to, the motor axis A1 when viewed in a plane parallel to the plane P1. In operation, if the user desires to use the handle 248, then the user may attach the handle 248 to the attachment recesses 240, 244. The pommel handle 46 may include apertures 249 (shown schematically in FIGS. 2 and 3) to allow a portion of the handle 248 to selectively pass through one of the apertures 249 such that the handle 248 (and more specifically, for example, a threaded portion of the handle 248) may be connected to a respective one of the attachment recesses 240, 244 through a side of the pommel handle 46.

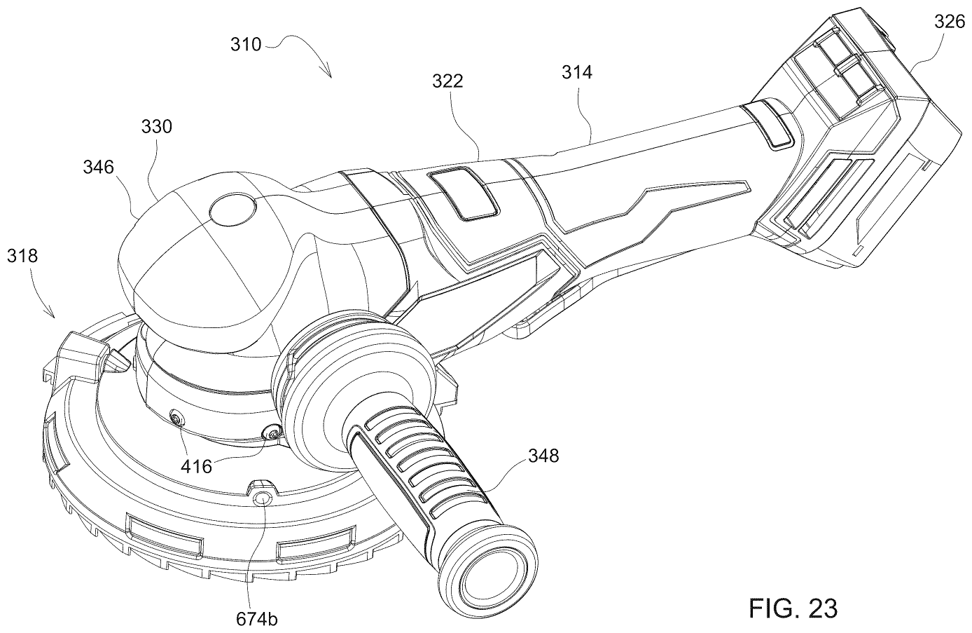

With reference to FIG. 23, a power tool 310 (e.g., a grinder such as a concrete grinder) includes a main body 314 and a dust shroud assembly 318. The main body 314 includes a handle portion 322, a battery pack receptacle 326 positioned at an end of the handle portion 322 distal from the dust shroud assembly 318, and a head portion 330 positioned at an end of the handle portion 322 proximal to the dust shroud assembly 318. The main body 314 includes a power switch 334 (e.g., a paddle switch 334) to selectively activate and deactivate the power tool 310. The power tool 310 may be powered by the battery pack 38 (shown schematically in FIG. 1) that is received in the battery pack receptacle 326. The battery pack 38 powers an electric motor (such as that shown schematically in FIG. 1 and shown in FIG. 8) that is positioned within the main body 314. The electric motor delivers rotational torque along a motor axis such as the motor axis A1 (shown in FIG. 1) which generally extends along the handle portion 322. The head portion 330 of the handle portion 322 includes a pommel handle 346.

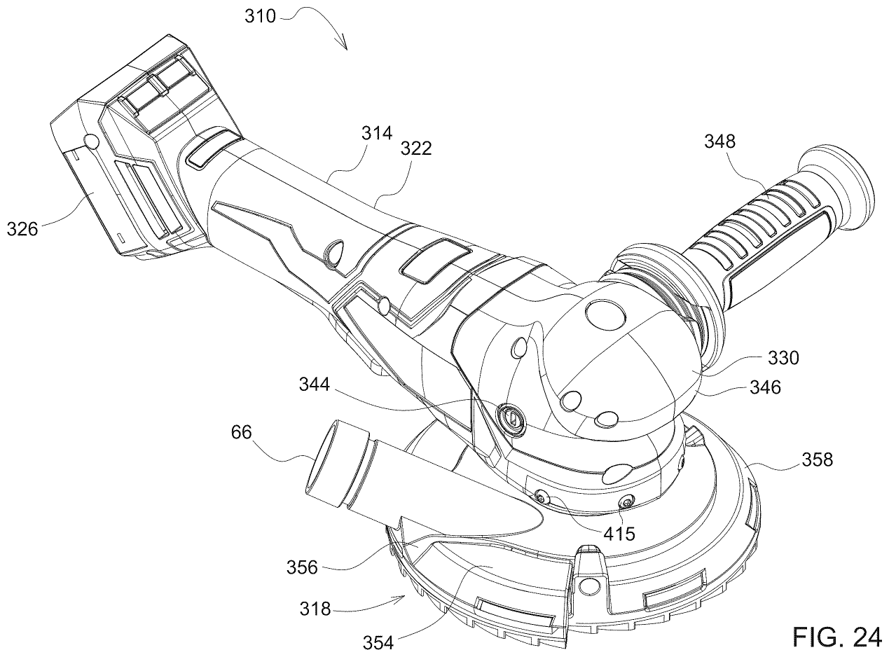

With continued reference to FIG. 23 and with reference to FIG. 24, an auxiliary handle 348 is selectively received in attachment recesses (such as the attachment recess 344 shown in FIG. 24) on either side of the head portion 330. The auxiliary handle 348 may be similar to the handle 248 shown in FIGS. 21 and 22, and the attachment recesses of the power tool 310 may be similar to the attachment recesses 240, 244.

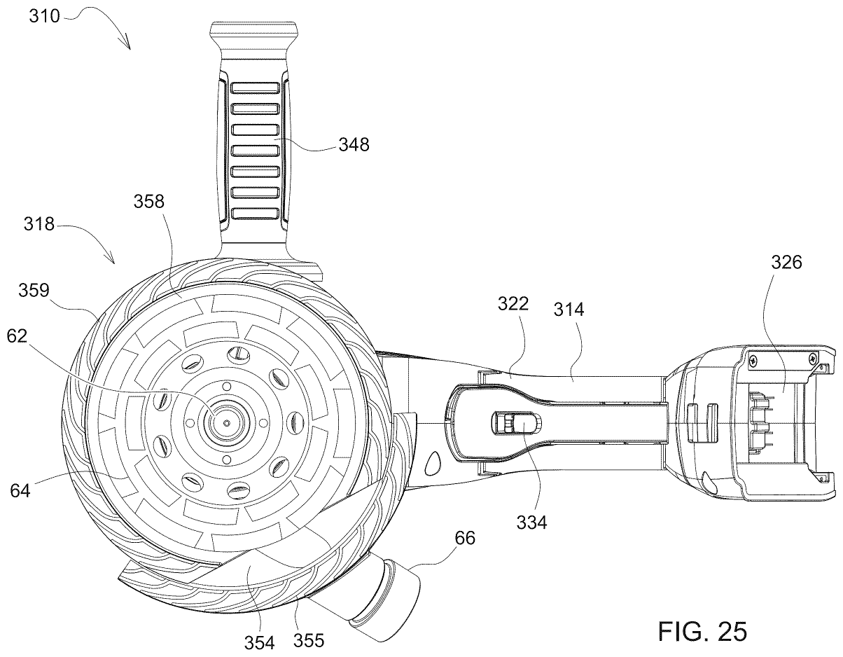

With continued reference to FIG. 24 and with reference to FIG. 25, the dust shroud assembly 318 includes an outer shroud 354 and an inner shroud 358 that surround the working tool 64 (e.g., a concrete grinding disk or concrete polish disk) which may be similar to the working tool 64 and may similarly include a working surface defining a plane P1 (shown in FIG. 3) and an arclength extending about a periphery of the working tool 64 similar to that shown in FIG. 5. The working tool 64 may be mounted to the output shaft 62 that transmits torque received from the electric motor. The outer shroud 354 includes an outer seal 355, and the inner shroud 358 includes an inner seal 359. The outer shroud 354 includes the dust extraction tube 66 extending from an upper side 370 of the outer shroud 354. In some embodiments, the dust extraction tube 66 may extend from a lateral sidewall 356 of the outer shroud 354 (FIG. 7). In some embodiments, the dust extraction tube 66 may extend parallel to the working surface and the plane P1. As described with reference to FIGS. 2-7, the dust extraction tube 66 may be connected to the outer shroud 354 with the moveable joint 67 (e.g., the rotatable joint 67).

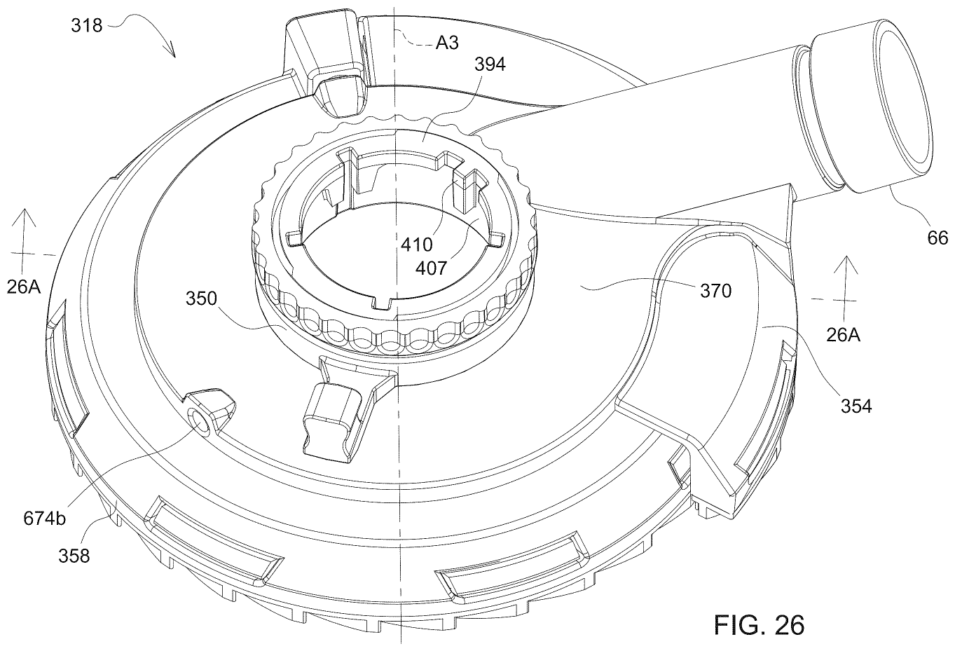

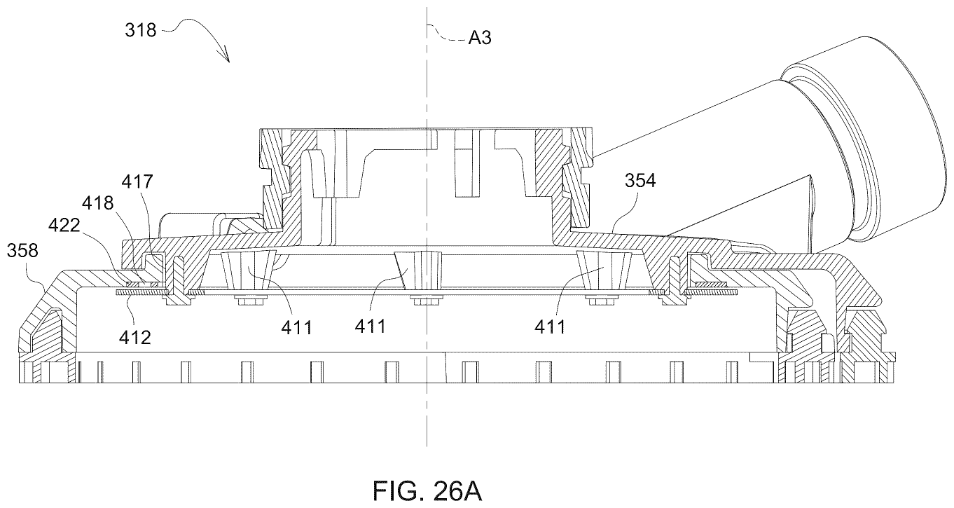

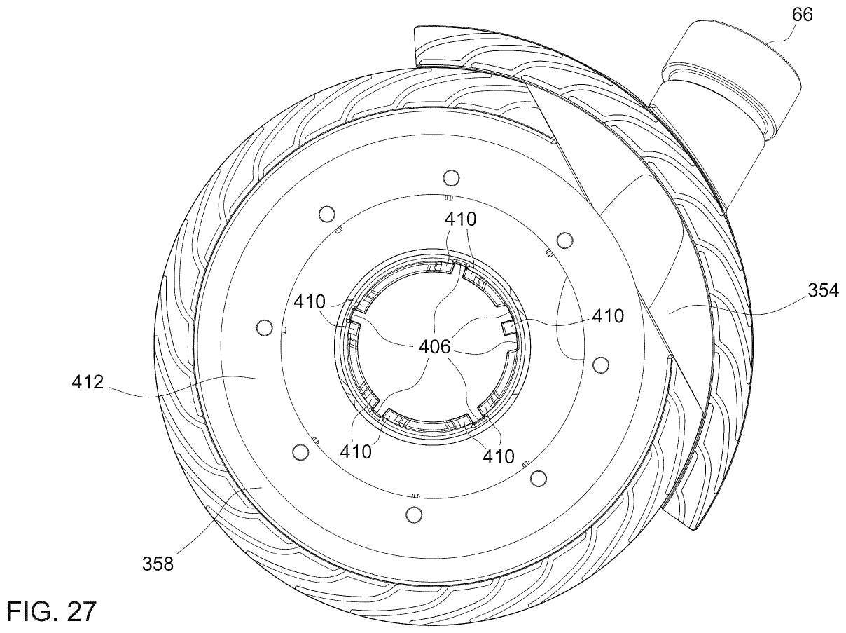

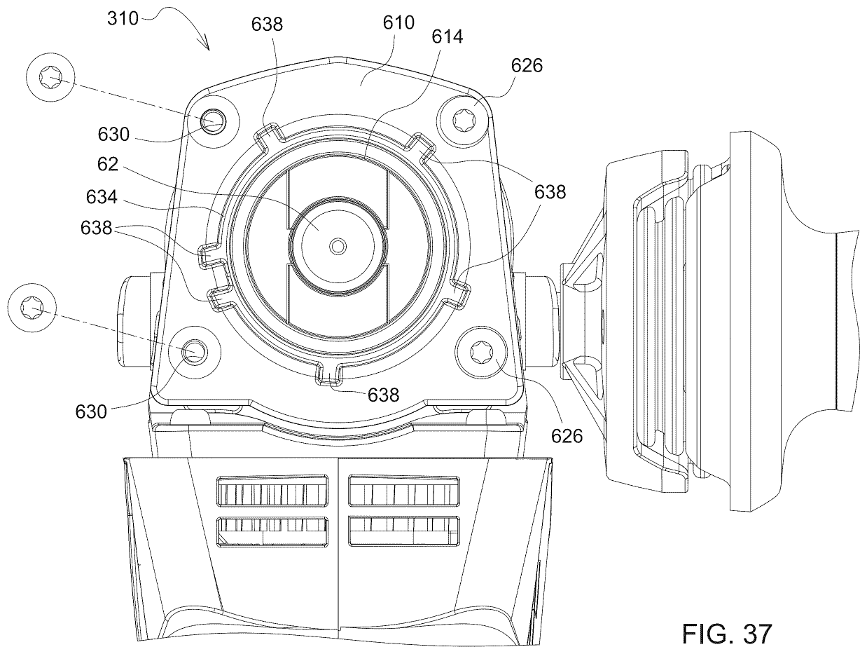

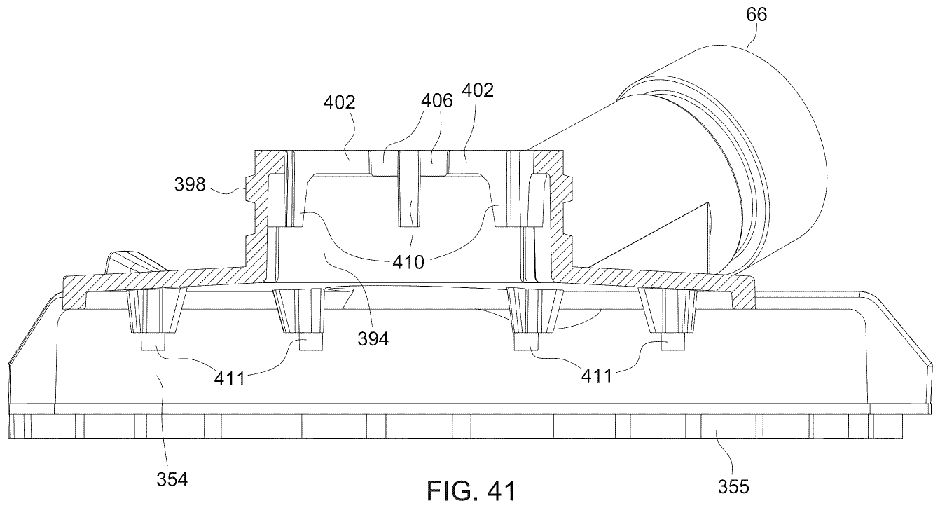

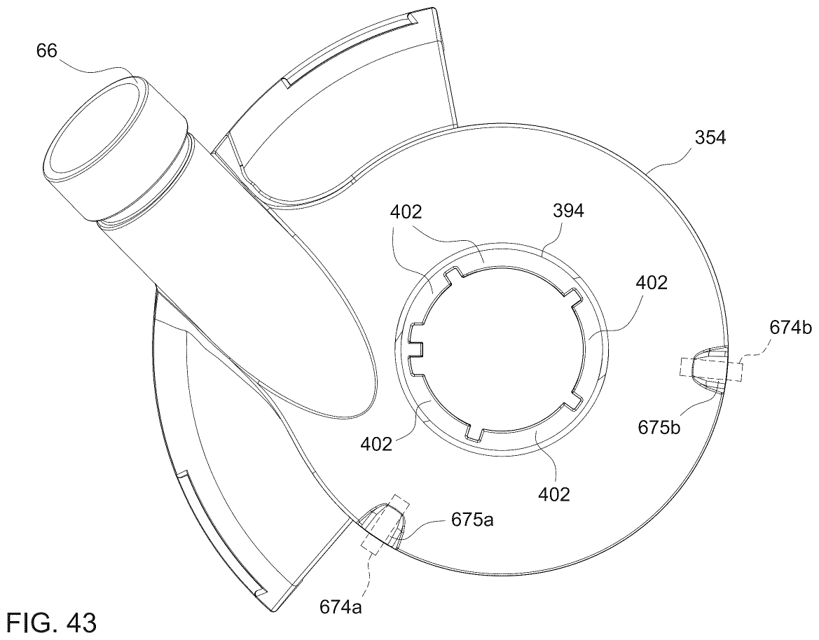

With reference to FIGS. 26-28 and 40-43, the inner shroud 358 pivots about the working tool rotational axis A3 relative to the outer shroud 354 between a closed position (e.g., a fully closed position) and an open position (e.g., a fully open position). The inner shroud 358 may pivot between multiple positions, including multiple open positions. In some embodiments, the inner shroud 358 may pivot between a fully open position and one or more partially open positions. The outer shroud 354 includes an upstanding hub portion 394 defining an outer shroud axis that may be parallel or collinear with the working tool rotational axis A3. The hub portion 394 is shaped as a cylinder having external threads 398 (FIG. 37). The hub portion 394 includes an inner circumferential protrusion 402 at a top of the hub portion 394 (i.e., at an open end of the hub portion 394 configured to be closest to the head portion 330). An inner surface of the hub portion 394 includes inner axial protrusions 410, some or all of which may be parallel to the outer shroud axis. The inner circumferential protrusion 402 may be periodically interrupted by smooth portions 406 that may cooperate to define a majority of an inner cylindrical surface 407 of the hub portion 394.

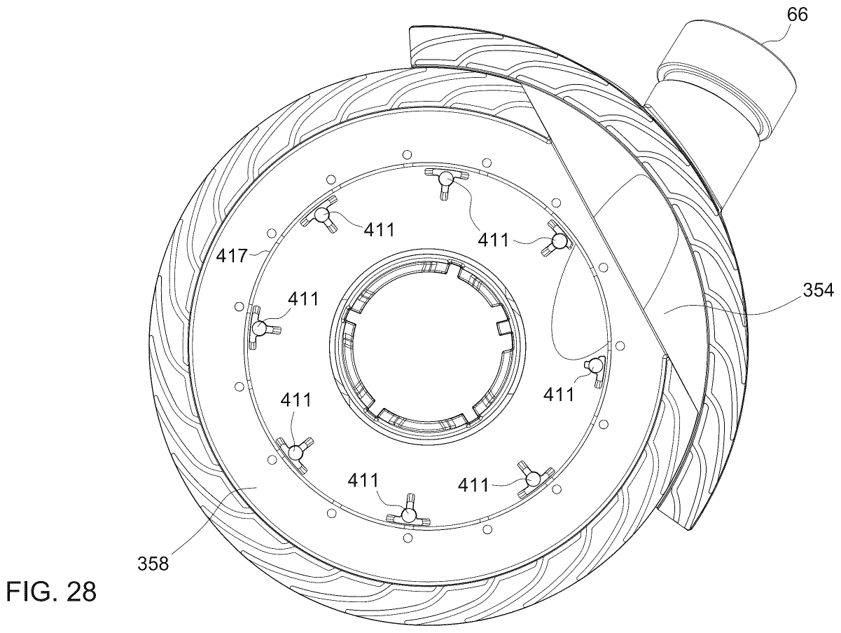

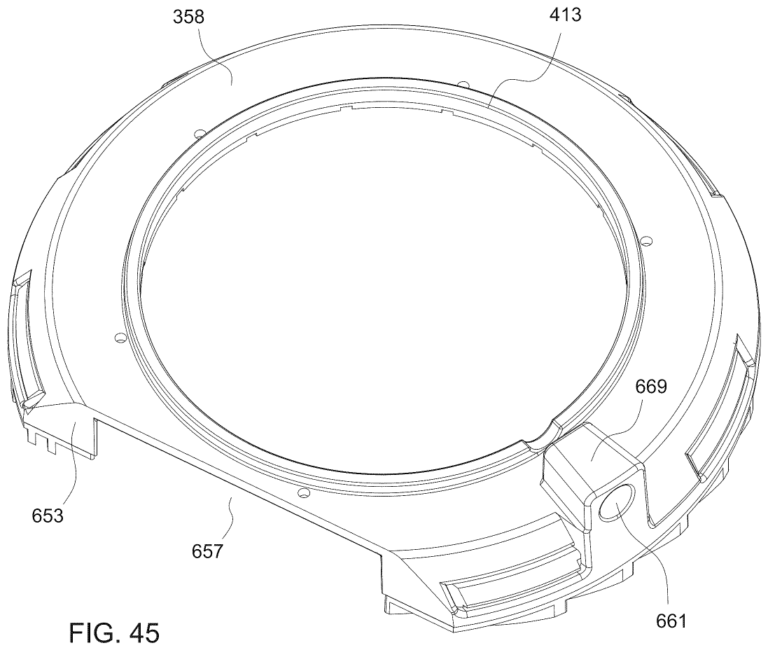

With reference to FIGS. 26A, 27, 28, and 45, the outer shroud 354 includes a plurality of pins 411 projecting downwardly (i.e., in a direction toward the working tool 64) and are positioned in a circle about the working tool rotational axis A3. An annular retaining plate 412 (e.g., a metal washer) is mounted to the pins 411 to cover a seam 417 between the outer shroud 354 and the inner shroud 358. In some embodiments, the pins 411 may be formed as screw bosses, and the retaining plate 412 may be mounted to the pins 411 via a variety of manners including heat staking, mounting with fasteners such as screws, etc. The outer shroud 354 may include a channel 418, and a metal insert 422 may be positioned within the channel 418. The metal insert 422 may contact the retaining plate 412 so that the metal insert 422 and the retaining plate 412 slide relative to each other without putting direct wear on plastic components of the outer shroud 354 or the inner shroud 358. In some embodiments, the metal insert 422 is insert molded with the inner shroud 358. The retaining plate 412 may support the inner shroud 358 relative to the outer shroud 354. More specifically, the retaining plate 412 may axially support the inner shroud 358 against a force of gravity such that the inner shroud 358 is maintained in close contact with the outer shroud 354 while also being also freely rotatable (e.g., pivotable) by a user between two or more positions relative to the outer shroud 354. The pins 411 are positioned within an inner bore 413 of the inner shroud 358 (see FIG. 45) and may contact the inner bore 413 to position the inner shroud 358 around the working tool rotational axis A3. The pins 411 may trace a circle when viewed along the working tool rotational axis A3 as shown in FIG. 28. In some embodiments, the pins 411 may serve as a pilot feature to center the inner shroud 358 with respect to the outer shroud 354 and about the working tool rotational axis A3. In some embodiments, one or more other features may serve as a pilot feature to center the inner shroud 358, and the pins 411 may not serve as a pilot feature.

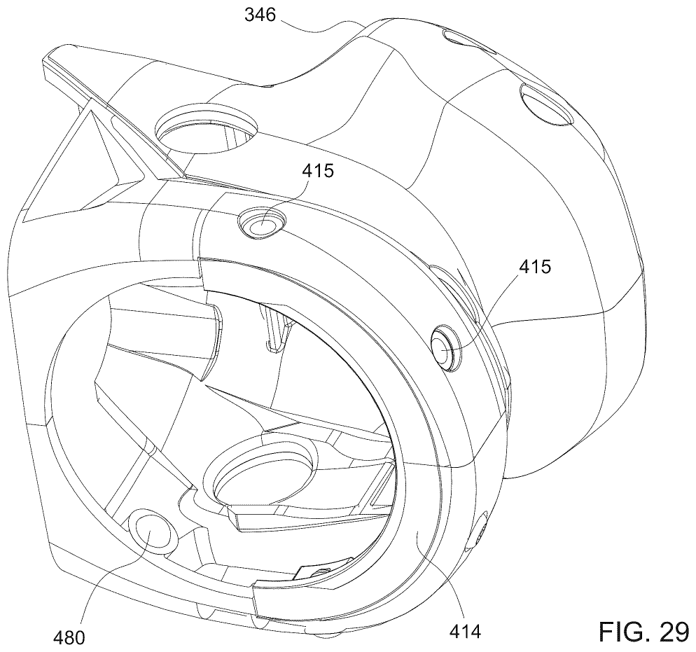

With reference to FIG. 29, the pommel handle 346 may include two clamshell halves that are fastened together by fasteners such as screws. A mounting flange 414 is positioned within the pommel handle 346 to interconnect the pommel handle 346 with an adjustment ring 350 (see, for example, FIG. 26). The mounting flange 414 is fastened to the pommel handle 346 by fasteners 416 (FIG. 23) such as screws that pass through bores 415 in the pommel handle 346. The mounting flange 414 fixes the adjustment ring 350 in a single axial position with respect to the pommel handle 346 along the working tool rotational axis A3 while allowing the adjustment ring 350 to rotate about the working tool rotational axis A3 to adjust an axial position of the outer shroud 354 and the inner shroud 358 relative to the working tool 64.

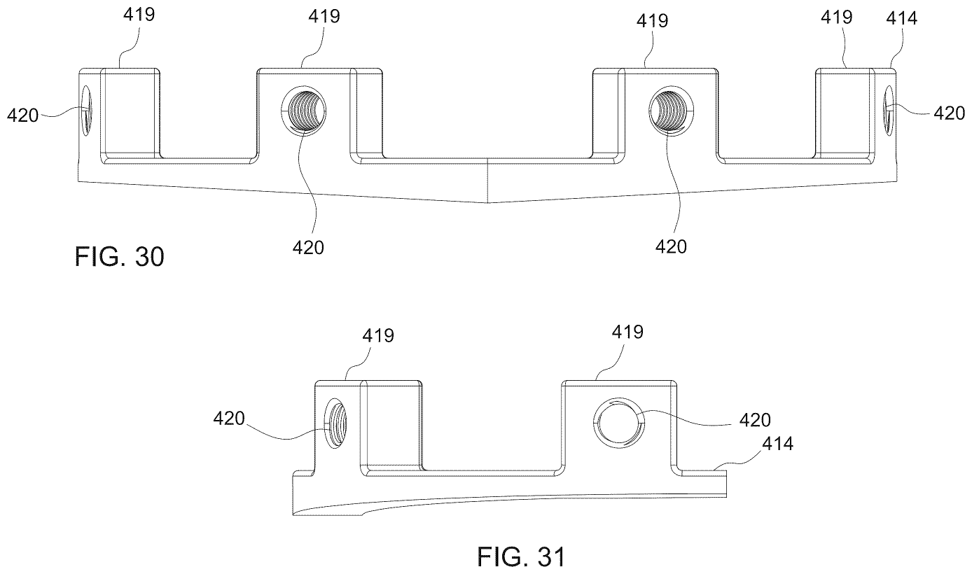

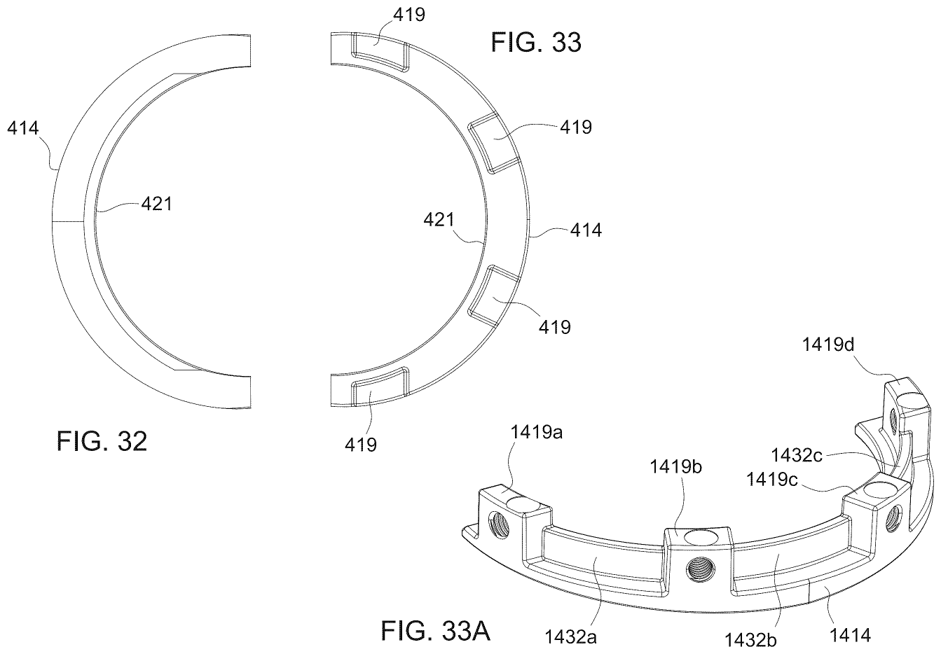

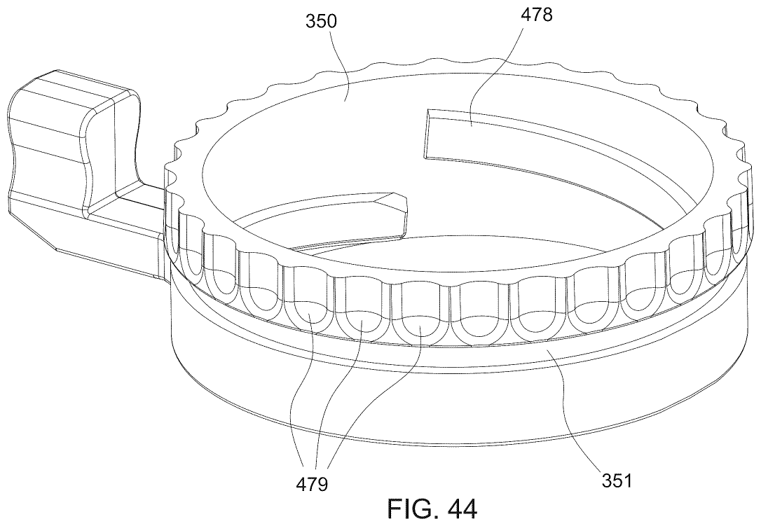

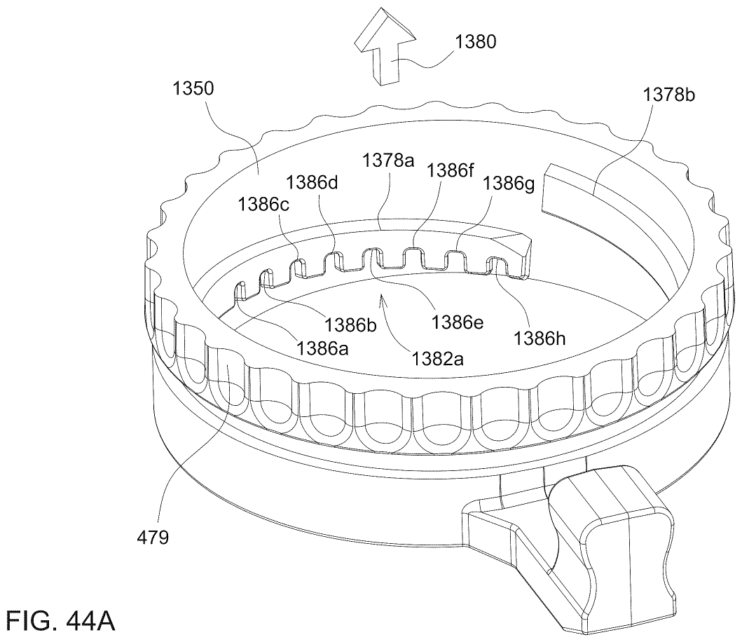

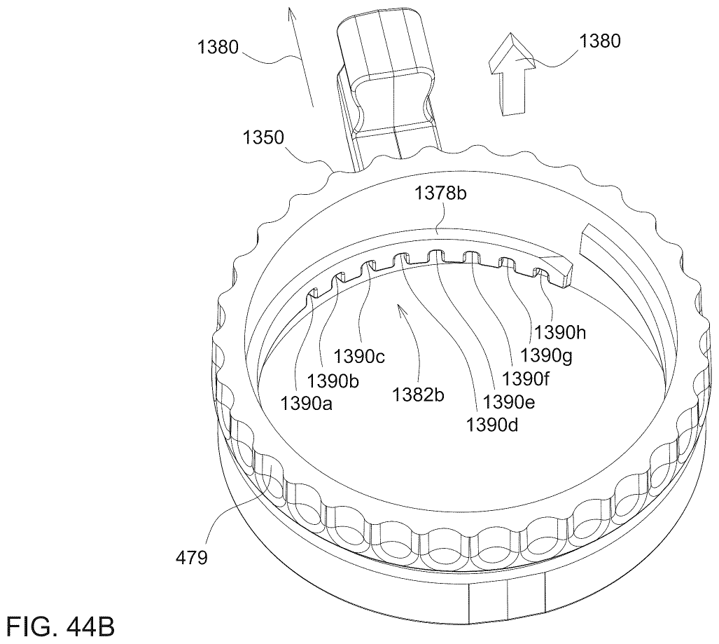

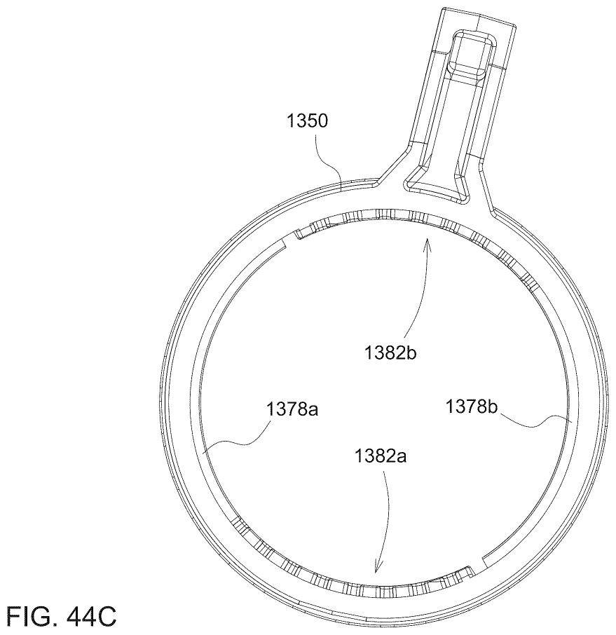

With reference to FIGS. 30-33, the mounting flange 414 includes a plurality of upstanding posts 419, each post 419 including a threaded bore 420 to receive one of the fasteners 416. The mounting flange 414 is curved about the working tool rotational axis A3 into a half-circle shape. The mounting flange 414 includes an inner edge 421 that engages with a circumferential recess 351 in the adjustment ring 350 (see FIG. 44) to axially retain the adjustment ring 350 in a direction parallel to the working tool rotational axis A3. In some embodiments, the circumferential recess 351 may extend 360 degrees about the adjustment ring 350. In some embodiments, the circumferential recess 351 may extend less than 360 degrees about the adjustment ring 350. For example, a tab may interrupt the circumferential recess 351 such that the circumferential recess 351 extends less than 360 degrees about the adjustment ring 350. An interruption in the circumferential recess 351 (such as a tab) may serve as a hard stop to limit a range of height adjustment permitted by the adjustment ring 350.

With reference to FIG. 33A, another embodiment of a mounting flange 1414 is shown that can be substituted for the mounting flange 414. The mounting flange 1414 includes a plurality of upstanding posts 1419a-1419d. As described with respect to FIGS. 30-33, each post 1419a-1419d may include a threaded bore to receive one of the fasteners 416. A plurality of webs 1432a-1432c may interconnect the posts 1419a-1419d. More specifically, an upstanding first web 1432a may interconnect a first post 1419a and a second post 1419b. An upstanding second web 1432b may interconnect the second post 1419b and a third post 1419c. An upstanding third web 1432c may interconnect the third post 1419c and a fourth post 1419d. The webs 1432a-1432c may be curved along a common arc to match an arc of the curvature of the mounting flange 1414.

With reference to FIGS. 29-33A, the pommel handle 346 allows a user to service the dust shroud assembly 318 or to replace the dust shroud assembly 318 with a different type of dust shroud assembly 318. To remove the dust shroud assembly 318, the user removes fasteners (e.g., four screws) from the bores 415 (FIG. 29). Then, the user slides the mounting flange 414 or 1414 (also known as a retainer 414 or 1414) and the dust shroud assembly 318 downward and out of the pommel handle 346. The dust shroud assembly 318 can then be cleaned and/or replaced with a different type of dust shroud assembly 318. In some embodiments, a method of servicing the dust shroud assembly 318 may include removing fasteners (e.g., screws) from the bores 415 that attach the mounting flange 414 or 1414 to the pommel handle 346. The method may include sliding the mounting flange 414 or 1414 and the dust shroud assembly 318 downward and out of the pommel handle 346. The method may include cleaning the dust shroud assembly 318 while it is removed from the pommel handle 346. The method may include replacing the dust shroud assembly 318 by inserting the mounting flange 414 or 1414 and the dust shroud assembly 318 upwards into the pommel handle and reattaching the fasteners through the bores 415 to affix the mounting flange 414 or 1414 to the pommel handle 346.

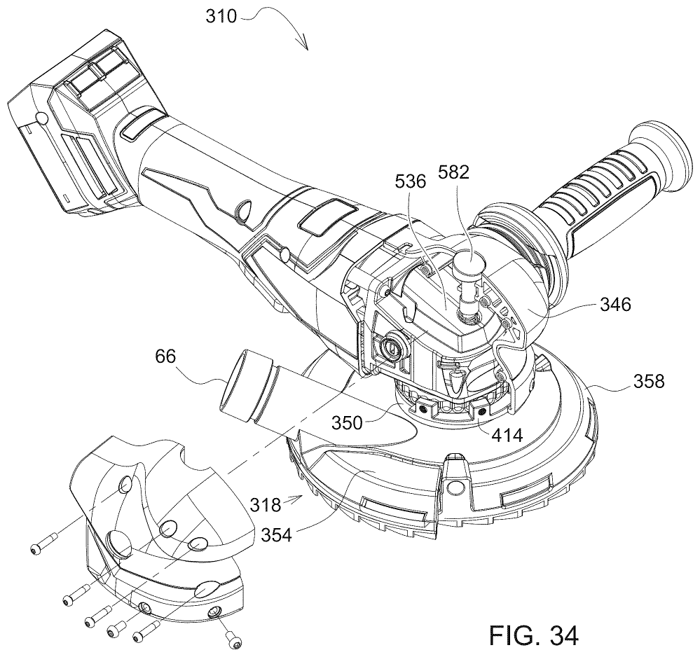

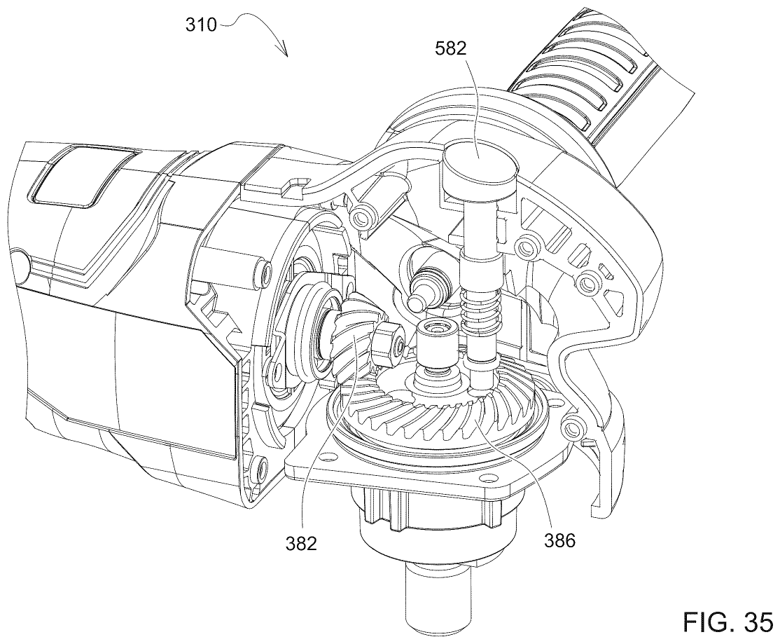

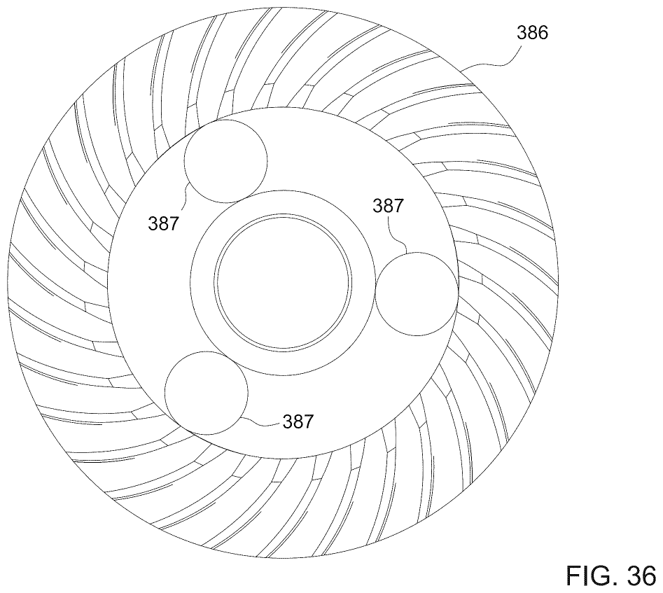

With reference to FIGS. 34-36, the power tool 310 includes a gearbox 536 and a spindle lock actuator 582 extending through the pommel handle 346 and into a top of the gearbox 536 to perform a spindle locking function (i.e., to inhibit rotation of the output shaft 62). The gearbox 536 encloses (i.e., houses) a pinion gear 382 driven by the electric motor for corotation therewith. The pinion gear 382 drives a ring gear 386, which is fixed to the output shaft 62 for corotation therewith. The ring gear 386 includes a plurality of recesses 387 provided on an upper surface (e.g., in a pinion gear-facing surface) of the ring gear 386. The recesses 387 selectively receive a spindle lock pin 383, the motion of which is controlled by the spindle lock actuator 582. In some embodiments, the spindle lock actuator 582 may constitute a spindle lock actuator sub-assembly held in place by clamshell halves such as the two clamshell halves of the pommel handle 346 or otherwise secured to the pommel handle 346. In some embodiments, the spindle lock pin 383 and the spindle lock actuator 582 may be integrally formed together as a single part such that the spindle lock actuator 582 is directly connected to the gearbox 536 and extends through the pommel handle 346.

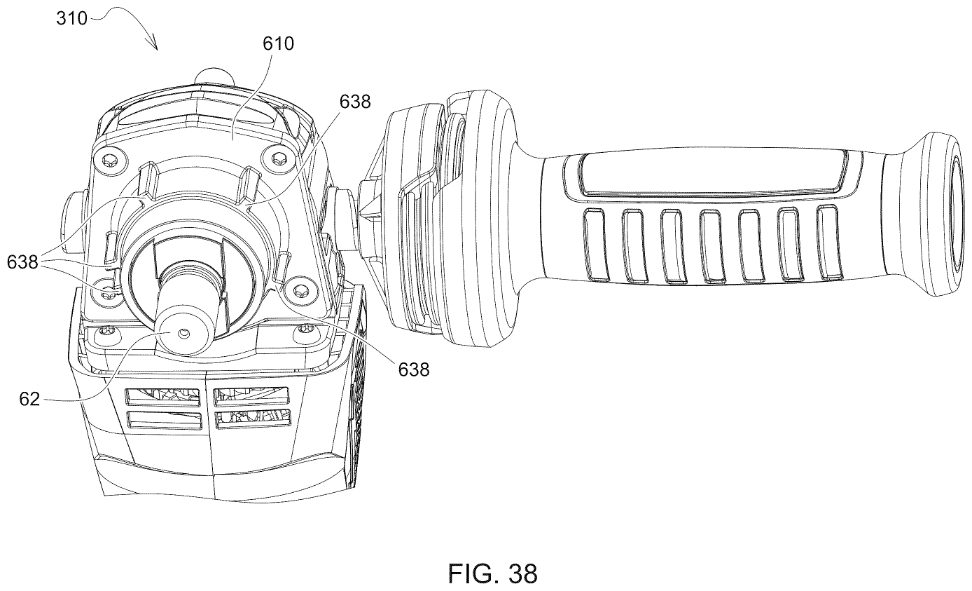

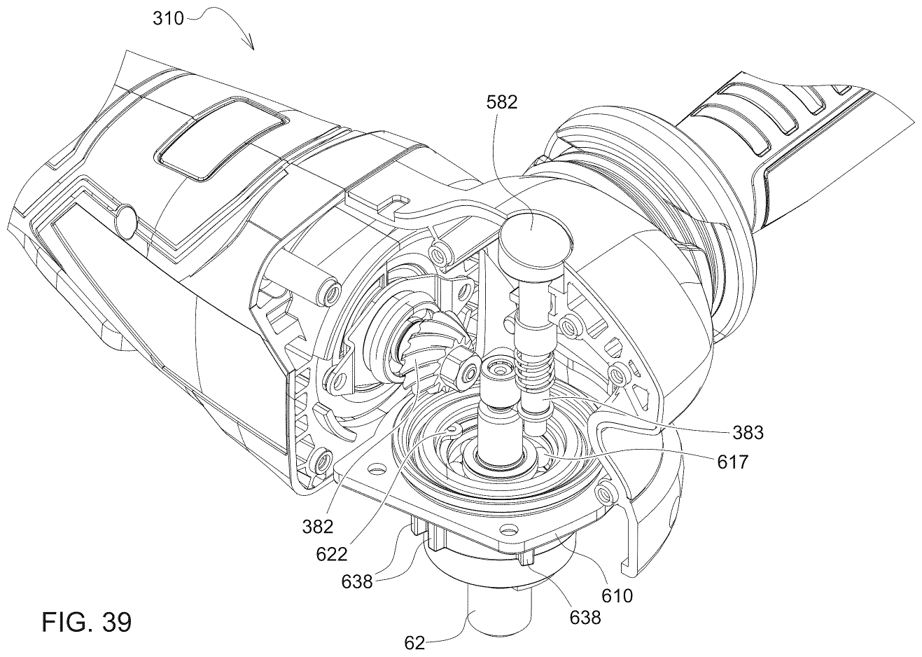

With reference to FIGS. 37-43, a support member 610 includes a cylindrical inner bore 614 that supports a bearing 617 that is secured in place by a snap ring 622. The bearing 617 supports the output shaft 62. The support member 610 is secured to a lower side of the gearbox 536 by fasteners 626 (e.g., screws such as hex-head screws) passing through bores 630. The support member 610 includes a generally cylindrical hub portion 634 with outer axial protrusions 638. The hub portion 634 is received within the hub portion 394 such that the inner axial protrusions 410 engage with the outer axial protrusions 638. In some examples, two or more of the inner axial protrusions 410 and two or more of the outer axial protrusions 638 may be spaced closer together compared to others of the inner axial protrusions 410 and the outer axial protrusions 638 to define one or more predetermined relative rotational orientations about the working tool rotational axis A3 at which the outer shroud 354 may engage the support member 610.

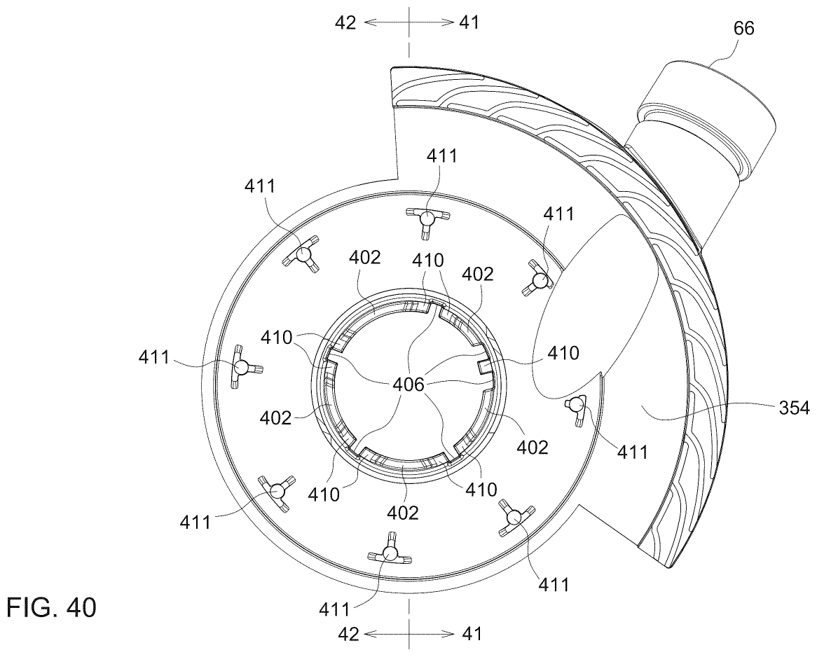

With continued reference to FIGS. 40-43, the outer shroud 354 includes one or more (and in the illustrated embodiment two) detent receiving recesses 674a, 674b. The outer shroud 354 (and more specifically, the detent receiving recesses 674a, 674b) may house a detent such as the detent 170 (e.g., a spring-loaded ball detent or a pin detent). The detent receiving recesses 674a, 674b may each be provided in an upstanding ear 675a, 675b on an upper side of the outer shroud 354.

With reference to FIG. 44, the adjustment ring 350 may be similar to the adjustment ring 50 except for certain differences as shown in the figures. The adjustment ring 350 includes internal threads 478 that engage with the external threads 398 on the outer shroud 354. The adjustment ring 350 includes detent recesses 479 positioned around an outer circumference of the adjustment ring 350. In some embodiments, the adjustment ring 350 may include detent recesses 479 positioned around a complete outer circumference of the adjustment ring 350. The detent recesses 479 receive a detent 480 (see FIG. 29) biased toward the detent recesses 479 by a biasing member such as a spring. Each detent recess 479 corresponds to a particular (e.g., different) adjustment height of the dust shroud assembly 318 relative to the working tool 64 and/or relative to the head portion 330.

With reference to FIGS. 44A-44C, another embodiment of an adjustment ring 1350 is shown that can be substituted for the adjustment rings 50, 350. The adjustment ring 1350 includes detent recesses 479 positioned around an outer circumference of the adjustment ring 350. In some embodiments, the adjustment ring 1350 may include detent recesses 479 positioned around a complete outer circumference of the adjustment ring 350. The detent recesses 479 may be positioned around an upper side of the adjustment ring 350 and may be open in an upward direction indicated by an upward arrow 1380. The adjustment ring 1350 includes internal threads having a first thread portion 1378a and a second thread portion 1378b. The first thread portion 1378a includes a first set of notches 1382a positioned at a bottom of the first thread portion 1378a such that the first set of notches 1382a is generally directed downwards (i.e., in a direction generally opposite the upward arrow 1380). The first set of notches 1382a may include eight first notches 1386a-1386h. The second thread portion 1378b includes a second set of notches 1382b positioned at a bottom of the second thread portion 1378b such that the second set of notches 1382b is generally directed downwards (i.e., in a direction generally opposite the upward arrow 1380). The second set of notches 1382b may include eight second notches 1390a-1390h.

With reference to FIG. 45, a chord 653 defines a portion of an outer periphery of the inner shroud 358, and the chord 653 includes a radial dust passage 657. The inner shroud 358 is rotatable relative to the outer shroud 354 (see FIGS. 40-43) to selectively open or close the radial dust passage 657 as described with respect to the inner shroud 358. The inner shroud 358 includes a detent receiving recess 661 provided in a grip portion 669. The grip portion 669 is upstanding from an upper side of the inner shroud 358. In some embodiments, a detent such as the detent 170 (e.g., a spring-loaded ball detent or a pin detent) may be provided in the detent receiving recess 661 and biased toward the detent receiving recesses 674a, 674b. In some embodiments, detents such as the detent 170 may be provided in the detent receiving recesses 674a, 674b and biased toward the detent receiving recess 661. The grip portion 669 may serve as a lever to rotate the inner shroud 358 relative to the outer shroud 354 from an open position (in which the detent receiving recess 661 is aligned with the detent receiving recess 674b) to a closed position (in which the detent receiving recess 661 is aligned with the detent receiving recess 674a.

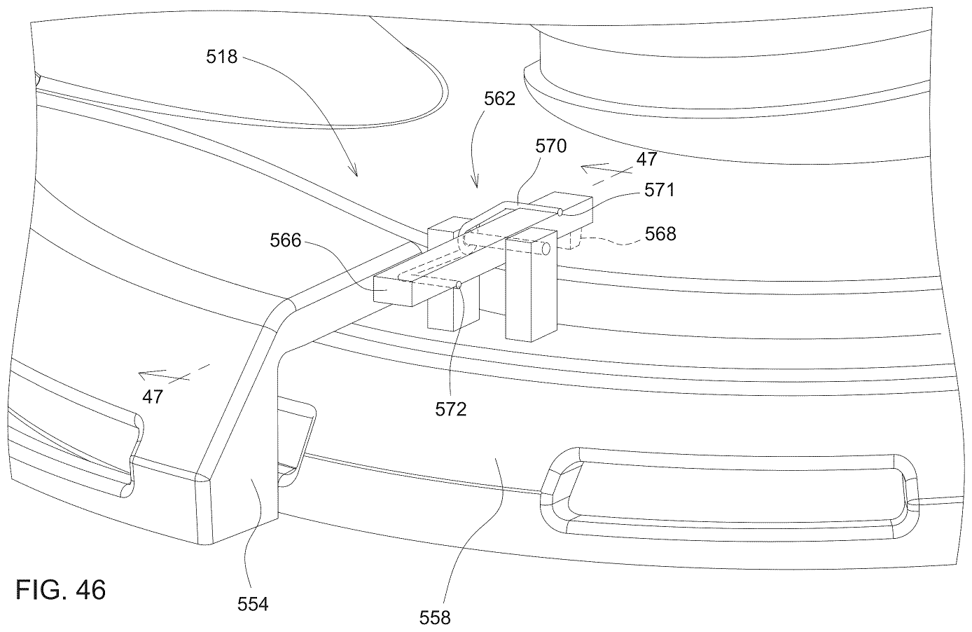

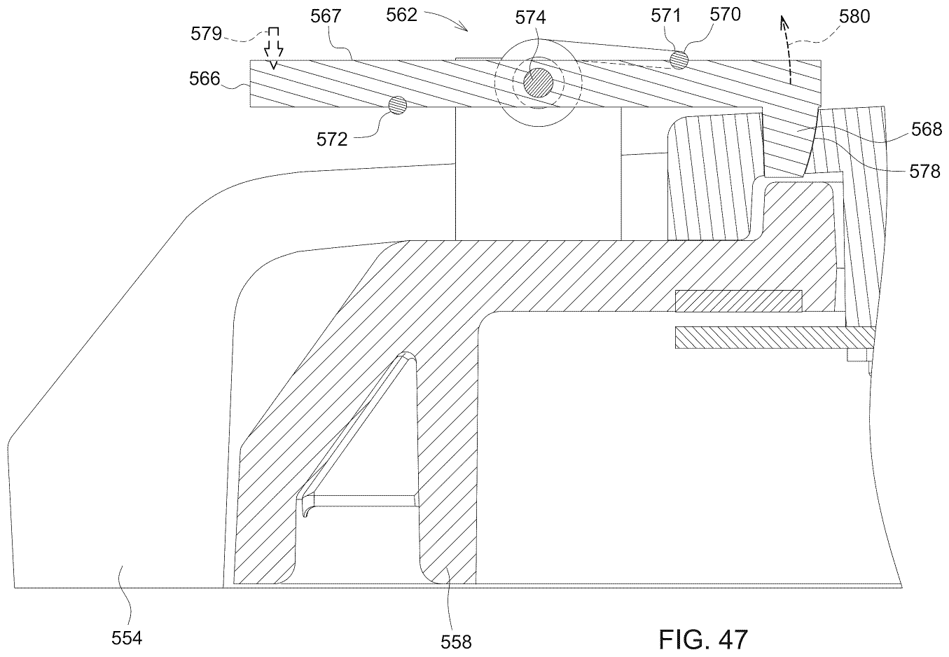

With reference to FIGS. 46 and 47, a dust shroud assembly 518 may be similar in some respects to the dust shroud assembly 318 for use with the power tool 310 and/or other power tools described herein except as shown and/or described herein. The dust shroud assembly 518 includes an outer shroud 554 and an inner shroud 558. The inner shroud 558 is pivotable relative to the outer shroud 554 as described elsewhere herein. A first latching assembly 562 selectively secures the inner shroud 558 at one or more positions relative to the outer shroud 554. The first latching assembly 562 includes a hook 566, a spring 570, and a fulcrum 574. The fulcrum 574 is coupled (e.g., affixed) to the inner shroud 558. The hook 566 includes an arm portion 567 and a hook portion 568. The outer shroud 554 includes one or more recesses 578 configured to receive the hook portion 568 of the hook 566. The hook 566 is pivotable between an engaged or locked position (shown in FIG. 47) in which the inner shroud 558 is pivotably affixed with respect to the outer shroud 554 and a disengaged or unlocked position. The spring 570 includes a first leg 571 and a second leg 572. The first leg 571 is positioned between the fulcrum 574 and the hook portion 568 and is positioned on a side of the hook 566 opposite the outer shroud 554 and the inner shroud 558 (for example, on top of the hook 566). The second leg 572 is positioned on an opposite side of the fulcrum 574 from the hook portion 568. The hook 566 is pivotably attached to the inner shroud 558 at the fulcrum 574, and the hook 566 may be selectively attached to the outer shroud 554 at one or more of the recesses 578. In operation, a user may apply a downward force 579 to a side of the hook 566 on an opposite side of the fulcrum 574 from the hook portion 568 to cause the hook to pivot in a direction 580 to overcome a bias of the spring 570 to move the hook 566 from the locked position (FIG. 47) to the unlocked position. When the hook 566 is in the unlocked position, the inner shroud 558 may be pivoted relative to the outer shroud 654 to obtain a desired relative position of the shroud 654, 658, the desired position being maintained by the first latching assembly 562.

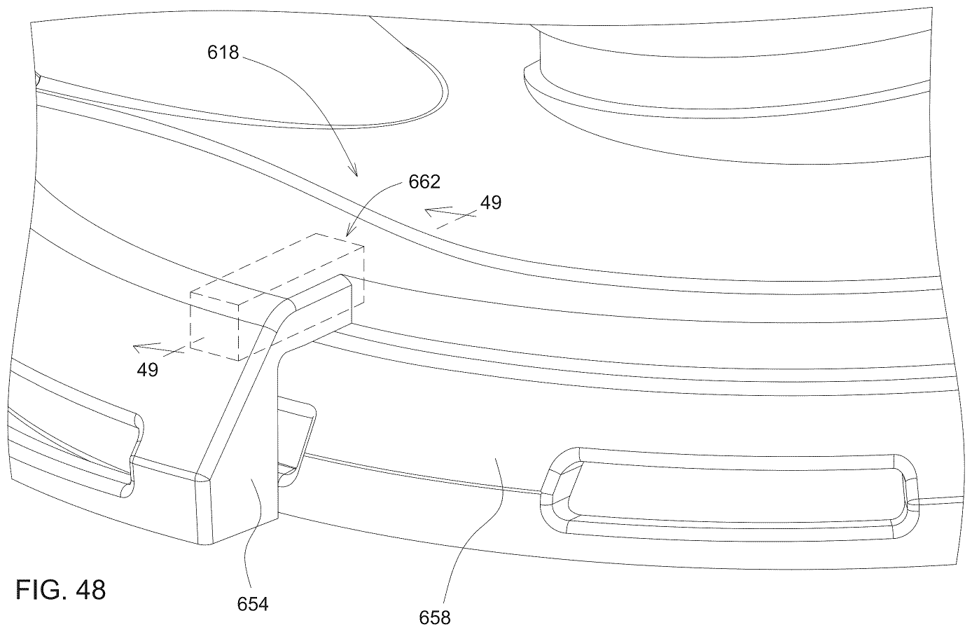

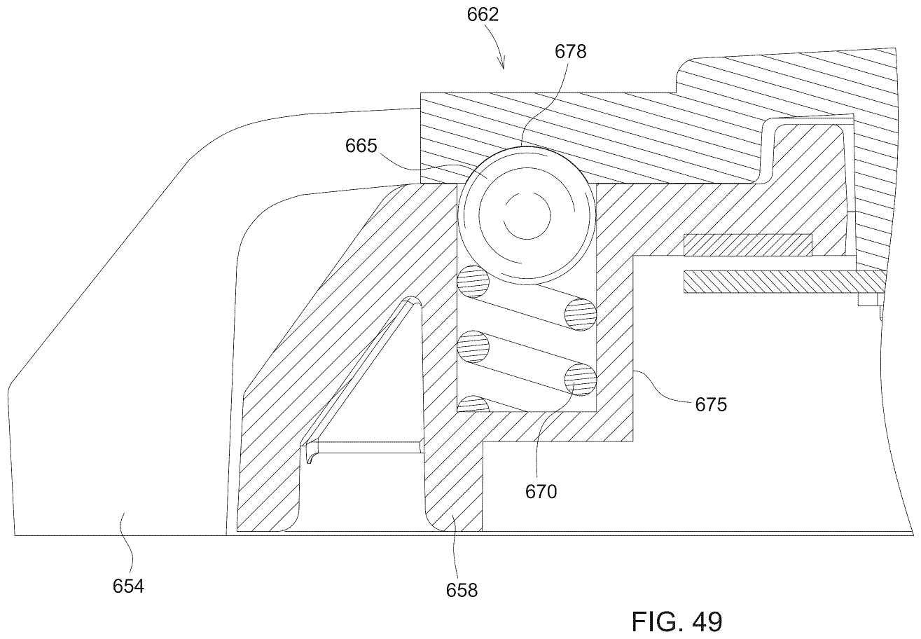

With reference to FIGS. 48 and 49, a dust shroud assembly 618 may be similar in some respects to the dust shroud assembly 318 for use with the power tool 310 and/or other power tools described herein except as shown and/or described herein. The dust shroud assembly 618 includes an outer shroud 654 and an inner shroud 658. The inner shroud 658 is pivotable relative to the outer shroud 654 as described elsewhere herein. A second latching assembly 662 selectively secures the inner shroud 658 at one or more positions relative to the outer shroud 654. The second latching assembly 662 includes a ball detent 665 and a spring 670. The ball detent 665 and the spring 670 are both positioned in a recess 675 in the inner shroud 658. One or more mating pockets 678 may be positioned in the outer shroud 654. In some embodiments, the ball detent 665 and the spring 670 may be positioned in a recess in the outer shroud 654, and the mating pockets 678 may be positioned in the inner shroud 658. The inner shroud 658 may be pivoted relative to the outer shroud 654. The spring 670 may bias the ball detent 665 toward the one or more mating pockets 678. Each mating pocket 678 corresponds to a position of the inner shroud 658 relative to the outer shroud 654 (e.g., an open position such as a fully open position and a closed position such as a fully closed position). In operation, a user may rotate the inner shroud 658 relative to the outer shroud 654 such that the second latching assembly 662 secures the dust shroud assembly 618 in a desired position.

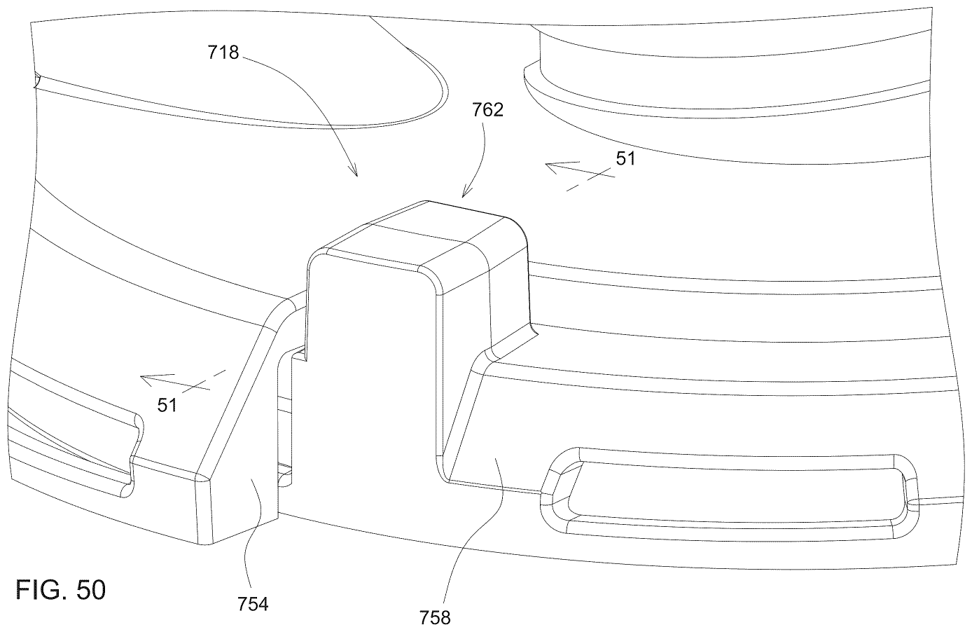

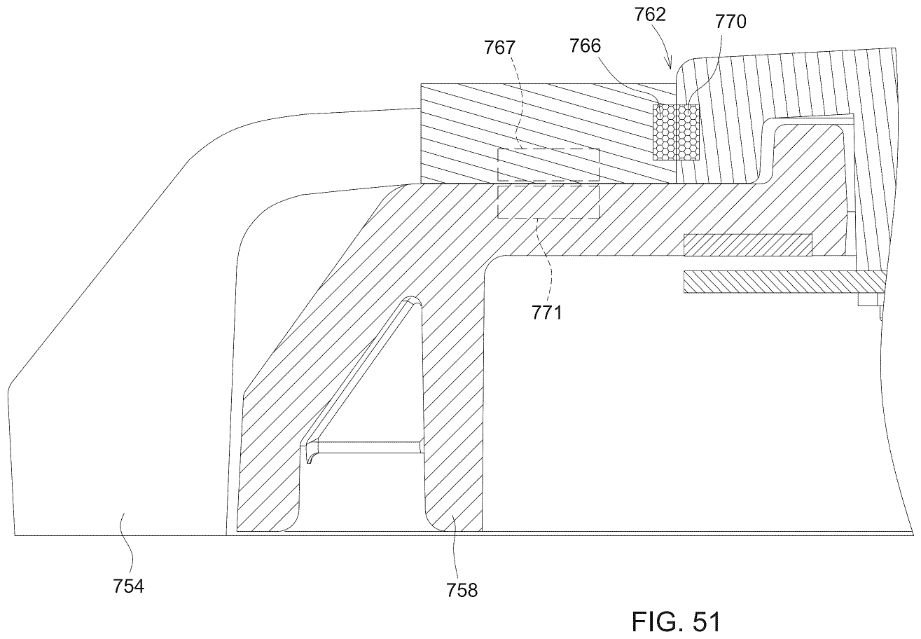

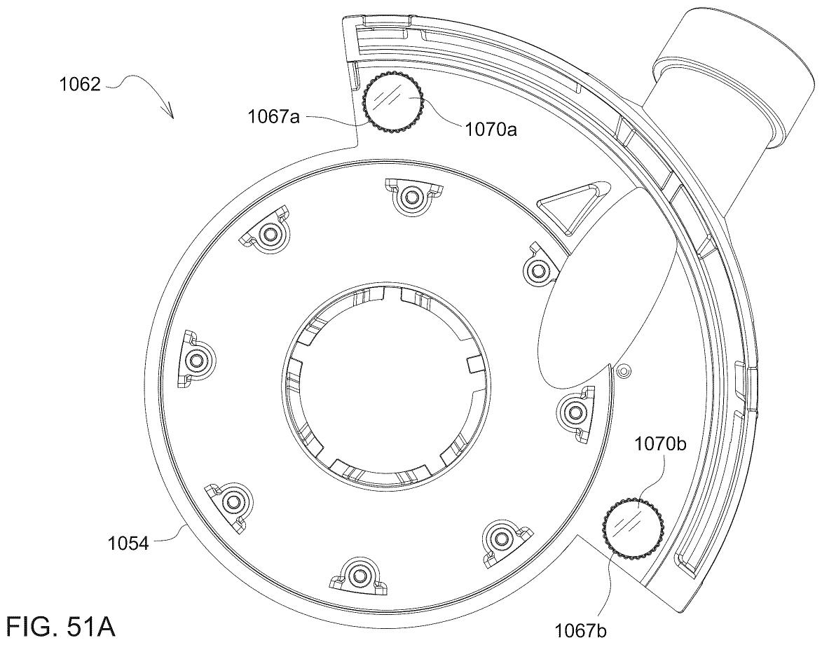

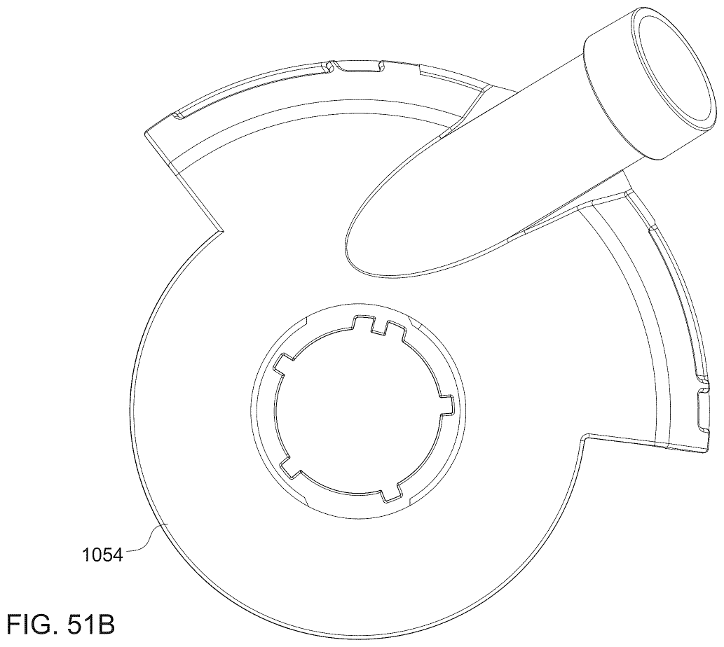

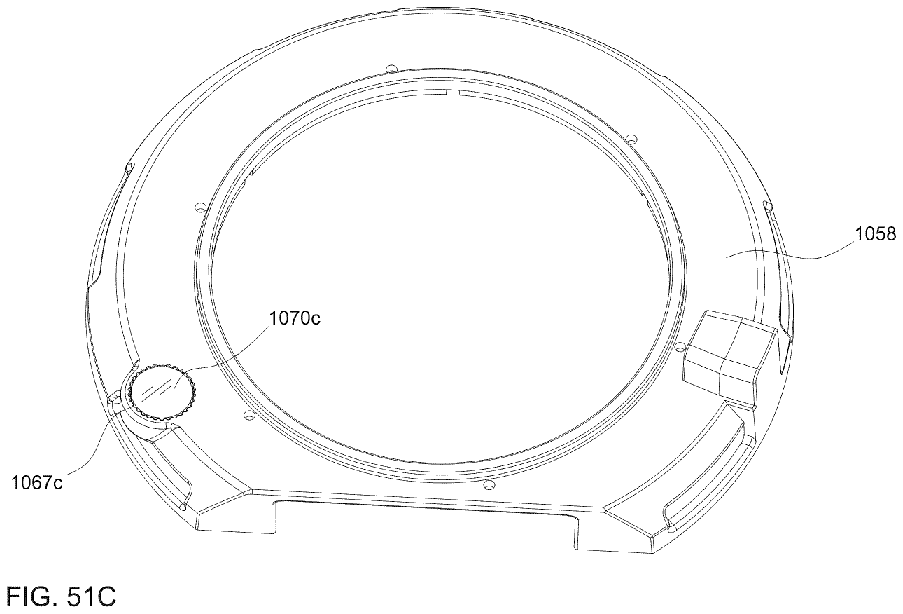

With reference to FIGS. 50 and 51, a dust shroud assembly 718 may be similar in some respects to the dust shroud assembly 318 for use with the power tool 310 and/or other power tools described herein except as shown and/or described herein. The dust shroud assembly 718 includes an outer shroud 754 and an inner shroud 758. The inner shroud 758 is pivotable relative to the outer shroud 754 as described elsewhere herein. A third latching assembly 762 selectively secures the inner shroud 758 at one or more positions relative to the outer shroud 754. The third latching assembly 762 includes a first magnet 766 affixed to the outer shroud 754 and a second magnet 770 affixed to the inner shroud 758. In some embodiments, the first magnet 766 and the second magnet 770 may engage each other radially as shown in FIG. 51 (that is, magnetically couple to each other radially relative to the working tool rotational axis A3). In some embodiments, the first magnet 766 may be positioned at a first alternative location 767 and the second magnet 770 may be positioned at a second alternative location 771, such that the magnets 766, 770 engage each other axially (that is, magnetically couple to each other vertically, or in a direction parallel or substantially parallel to an axial direction of the working tool rotational axis A3). In some embodiments, first magnets 766 may be positioned in both the location of the first magnets 766 shown in FIG. 51 and also in the first alternative location 767, and second magnets 770 may be positioned in both the location of the second magnets 770 shown in FIG. 51 and also in the second alternative location 771. In some embodiments, the dust shroud assembly 718 may include a plurality of first magnets 766 and/or may include a plurality of second magnets 770. The first magnets 766 and the second magnets 770 may be positioned such that a relative position of the first magnets 766 and the second magnets 770 define one or more positions of the dust shroud assembly (i.e., define one or more positions of the inner shroud 758 relative to the outer shroud 754) such as an open position (e.g., a fully open position or a partially open position) and a closed position (e.g., a fully closed position or a partially closed position).

In some embodiments, a user may open the dust shroud assembly 718 beyond an open position that is defined by the magnets 766, 770, and in some embodiments, a user may close the dust shroud assembly 718 beyond a closed position that is defined by the magnets 766, 770. A user may rotate the inner shroud 758 relative to the outer shroud 754 between the positions such that the magnets 766, 770 cooperate to hold the inner shroud 758 and the outer shroud 758 in a desired position until changed by the user. In some embodiments, the outer shroud 754 may include one first magnet 766, and the inner shroud 758 may include a plurality of second magnets 770, each second magnet 770 defining a position of the inner shroud 758 relative to the outer shroud 754. In some embodiments, the inner shroud 758 may include one second magnet 770, and the outer shroud 754 may include a plurality of first magnets 766, each first magnet 766 defining a position of the inner shroud 758 relative to the outer shroud 754.

In some embodiments, the magnets 766, 770 may be press-fit and/or glued into recesses in the dust shroud assembly 718. In some embodiments, the first magnet 766 that is affixed to the outer shroud 754 may be replaced with a ferromagnetic mass such as a lump of iron or another element that is magnetically attracted to the second magnet 770 that is affixed to the inner shroud 758. In some embodiments, the second magnet 770 that is affixed to the inner shroud 758 may be replaced with a ferromagnetic mass such as a lump of iron or another element that is magnetically attracted to the first magnet 766 that is affixed to the outer shroud 754. For the purposes of this disclosure, the term “magnetic element” includes any element that generates a magnetic field or that reacts to a magnetic field such as a magnet (e.g., a rare earth magnet, an electromagnet, etc.) or a magnetic metal (e.g., a ferromagnetic metal such as iron). In some embodiments, the first magnet 766 and the second magnet 770 may generally be replaced by magnetic elements that are attracted to each other to allow a user to selectively lock the inner shroud 758 and the outer shroud 754 in one or more relative positions.

With reference to FIGS. 51A-51C, an embodiment of a magnetic latching assembly 1062 selectively secures an inner shroud 1058 at one or more positions relative to the outer shroud 1054. With reference to FIG. 51A, the outer shroud 1054 includes a first recess 1067a for receiving and holding a first magnet 1070a (e.g., a first outer shroud magnet) in the first recess 1067a. The outer shroud 1054 includes a second recess 1067b for receiving and holding a second magnet 1070b (e.g., a second outer shroud magnet) in the second recess 1067b. With reference to FIG. 51B, an upper side of the outer shroud 1054 may not include any visible indication of the magnetic latching assembly 1062. With reference to FIG. 51C, the inner shroud 1058 includes a third recess 1067c for receiving and holding a third magnet 1070c (e.g., an inner shroud magnet) in the third recess 1067c. The third magnet 1070c selectively magnetically couples to the first magnet 1070a and the second magnet 1070b as the inner shroud 1058 is rotated between a first position (e.g., an open position such as a fully open or partially open position) and a second position (e.g., a closed position such as a fully closed or partially closed position). In some embodiments, a user may open the inner shroud 1058 beyond an open position that is defined by one or more of the magnets 1070a, 1070b, 1070c, and in some embodiments, a user may close the inner shroud 1058 beyond a closed position that is defined by one or more of the magnets 1070a, 1070b, 1070c. For example, in the closed position, the first magnet 1070a may be axially aligned with the third magnet 1070c such that the first magnet 1070a and the third magnet 1070c magnetically couple to each other to retain the outer shroud 1054 and the inner shroud 1058 in the closed position until displaced by a user's rotation of the inner shroud 1058 (e.g., to achieve the open position). As another example, in the open position, the second magnet 1070b may be axially aligned with the third magnet 1070c such that the second magnet 1070b and the third magnet 1070c magnetically couple to each other to retain the outer shroud 1054 and the inner shroud 1058 in the open position until is placed by a user's rotation of the inner shroud 1058 (e.g., to achieve the closed position).

In some embodiments, the magnets 1070a, 1070b, 1070c may be press-fit and/or glued into the respective recesses 1067a, 1067b, 1067c. In some embodiments, the magnets 1070a, 1070b that are affixed to the outer shroud 1054 may be replaced with ferromagnetic masses such as lumps of iron or other elements that are magnetically attracted to the magnet 1070c that is affixed to the inner shroud 1058. In some embodiments, the magnet 1070c that is affixed to the inner shroud 1058 may be replaced with a ferromagnetic mass such as a lump of iron or another element that is magnetically attracted to the magnets 1070a, 1070b that are affixed to the outer shroud 1054. In some embodiments, the magnets 1070a, 1070b, 1070c may generally be replaced by magnetic elements such that the magnetic element 1070c is attracted to the magnetic element 1070a, and vice versa, and such that the magnetic element 1070c is attracted to the magnetic element 1070b, and vice versa, to allow a user to selectively lock the inner shroud 1058 and the outer shroud 1054 in one or more relative positions.

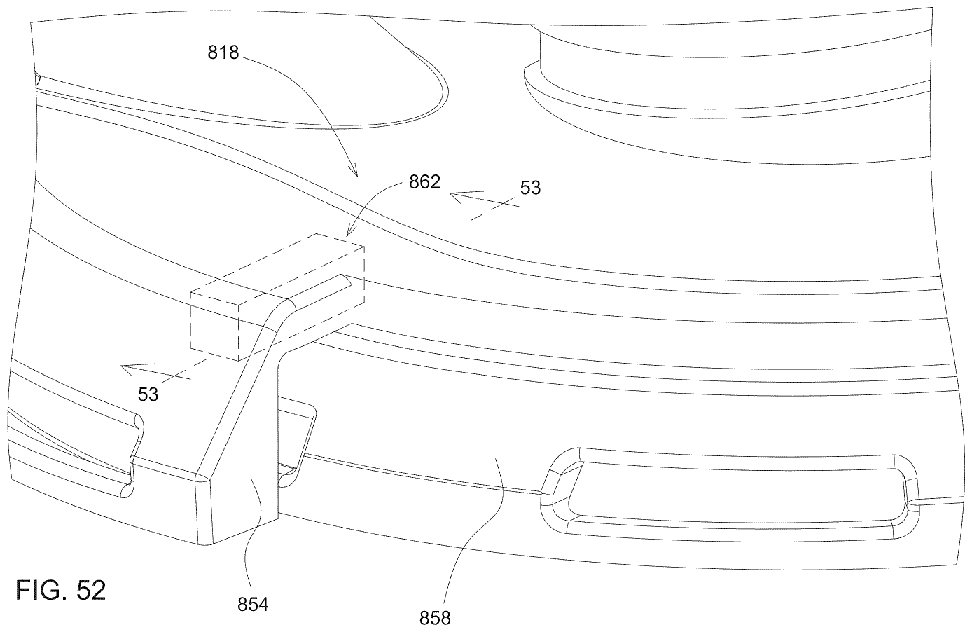

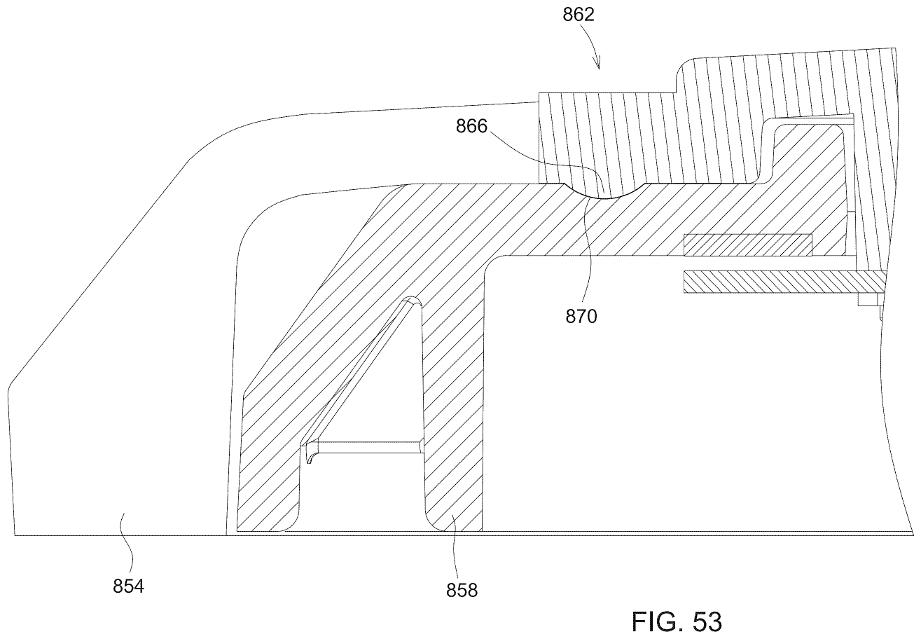

With reference to FIGS. 52 and 53, a dust shroud assembly 818 may be similar in some respects to the dust shroud assembly 318 for use with the power tool 310 and/or other power tools described herein except as shown and/or described herein. The dust shroud assembly 818 includes an outer shroud 854 and an inner shroud 858. The inner shroud 858 is pivotable relative to the outer shroud 854 as described elsewhere herein. A fourth latching assembly 862 selectively secures the inner shroud 858 at one or more positions relative to the outer shroud 854 (e.g., an open position such as a fully open position and/or a closed position such as a fully closed position). The fourth latching assembly 862 includes one or more locking bumps 866 and one or more mating pockets 870. More specifically, in some embodiments, the outer shroud 854 may include the one or more locking bumps 866, and the inner shroud may include the one or more mating pockets 870. In some embodiments, the inner shroud 858 may include the one or more locking bumps 866, and the outer shroud 854 may include the one or more mating pockets 870. The locking bumps 866 may have an interference-fit connection with the mating pockets 870. A user may rotate the inner shroud 858 relative to the outer shroud 854 such that a desired position is obtained in which the locking bump (or bumps) engage with the desired mating pocket (or pockets) 870 to hold the dust shroud assembly 818 in the desired position until changed by the user.

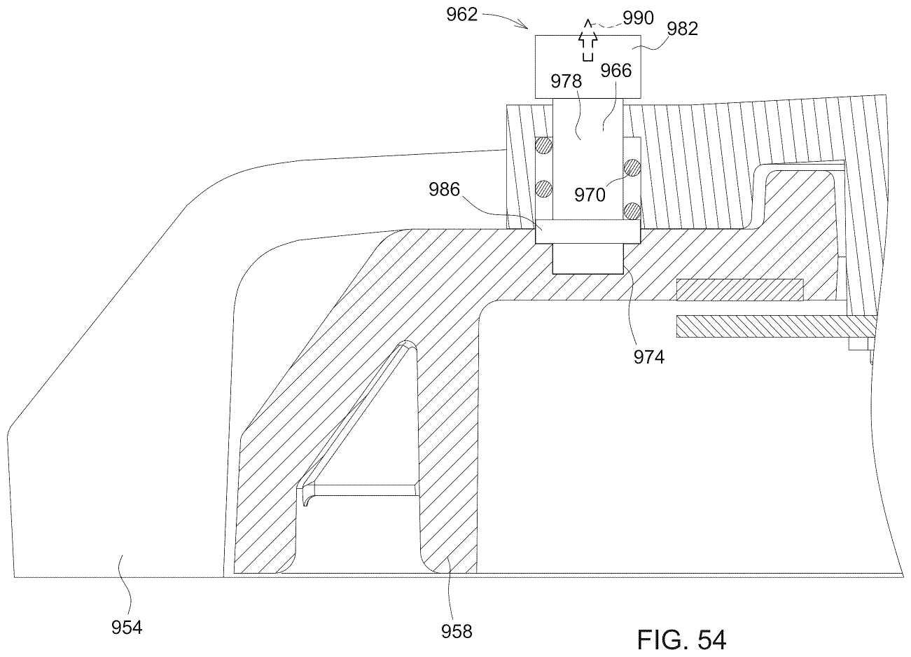

With reference to FIG. 54, a fifth latching assembly 962 for selectively latching an outer shroud 954 and an inner shroud 958 may include a pin 966, a spring 970, and one or more mating pockets 974. The pin 966 may include a shaft portion 978 and a knob portion 982. A retention ring 986 (e.g., a snap ring) may inhibit the pin 966 from falling out of the outer shroud 954. The inner shroud 958 is pivotable relative to the outer shroud 954 as described elsewhere herein. The mating pockets 974 may be provided in the inner shroud 958. Each mating pocket 974 may correspond to a position of the inner shroud 958 relative to the outer shroud 954 such that the fifth latching assembly 962 secures a dust shroud assembly in a desired position. In operation, a user may pull the knob portion 982 in an upwards direction 990, against a bias of the spring 970, to disengage the shaft portion 978 from one of the mating pockets 974 such that the inner shroud 958 may be rotated relative to the outer shroud 954 (e.g., to change from an open position such as a fully open position to a closed position such as a fully closed position, or vice versa). The user may release the knob portion 982 to allow the shaft portion 978 to engage one of the mating pockets 974 under the force of the bias of the spring 970.

Although the invention has been described in detail with reference to certain preferred embodiments, variations and modifications exist within the scope and spirit of one or more independent aspects of the invention as described.

1. A grinding tool comprising:
a main body including a head portion;
an electric motor;
an output shaft configured for transmitting torque received from the electric motor;
a grinding disk attached to the output shaft and configured for rotation therewith about a grinding disk rotational axis;
a dust shroud assembly at least partially surrounding the grinding disk, the dust shroud assembly including an outer shroud and an inner shroud rotatable relative to the outer shroud, and
a rotatable adjustment ring defining an adjustment ring axis, the adjustment ring including a handle configured to allow a user to rotate the adjustment ring about the adjustment ring axis to adjust an axial position of the dust shroud assembly along the grinding disk rotational axis, wherein:
the outer shroud includes an upstanding hub portion rotationally affixed to the head portion of the main body, the hub portion at least partially configured as a cylinder defining a hub portion axis, the hub portion having external threads,
the adjustment ring includes internal threads configured to mate with the external threads on the hub portion such that rotation of the adjustment ring results in axial movement of the dust shroud assembly along the grinding disk rotational axis, and
the adjustment ring includes a plurality of adjustment ring detent recesses positioned around an outside of the adjustment ring on an opposite and radially external side of the adjustment ring from the internal threads.

2. The grinding tool of claim 1, wherein the outer shroud includes a plurality of pins projecting in a direction along the grinding disk rotational axis toward the grinding disk, the plurality of pins positioned in a circle about the grinding disk rotational axis.

3. The grinding tool of claim 1, wherein:
the hub portion is an outer hub portion,
the inner shroud includes an upstanding inner hub portion at least partially configured as a cylinder defining an inner hub portion axis, the inner hub portion configured to fit within the outer hub portion to attach the outer shroud to the inner shroud, and
the inner hub portion includes a plurality of upstanding projections positioned about the inner hub portion axis, each upstanding projection including a hook oriented radially outwardly relative to the inner hub portion axis.

4. The grinding tool of claim 3, wherein:
the hub portion includes an inner circumferential protrusion at a base of the hub portion,
the inner circumferential protrusion is interrupted by smooth portions that are flush with a majority of a radially inner surface of the hub portion,
the hub portion includes pairs of inner axial protrusions,
each pair of inner axial protrusions is positioned above one of the smooth portions, and
the hooks of the inner hub portion are configured to engage the inner circumferential protrusion of the hub portion to inhibit separation of the inner shroud from the outer shroud.

5. The grinding tool of claim 3, wherein a gap between adjacent upstanding projections spans a first proportion of an arclength of the grinding disk, wherein at least one of the upstanding projections spans a second proportion of the arclength of the grinding disk, and wherein the first proportion of the arclength is approximately equal to the second proportion of the arclength.

6. The grinding tool of claim 1, further comprising a dust extraction tube extending from the outer shroud, and wherein:
the main body includes a handle portion;
the main body includes a battery pack receptacle positioned at a first end of the handle portion, the battery pack receptacle configured to receive a battery pack for powering the electric motor,
the electric motor is positioned within the main body,
the head portion is positioned at a second end of the handle portion opposite the first end,
the grinding tool is a concrete grinder, and
the grinding disk is a concrete grinding disk.

7. The grinding tool of claim 1, wherein:
the outer shroud includes a first arcuate wall portion having a first horizontal segment extending radially outward from the hub portion relative to the grinding disk rotational axis, and the first arcuate wall portion includes a first vertical segment circumferentially extending around less than 180 degrees of an arclength of the grinding disk,
the inner shroud includes:
a hand grip configured for rotating the inner shroud,
a second arcuate wall portion having a second horizontal segment extending radially outward relative to the grinding disk rotational axis,
a second vertical segment circumferentially extending around more than 180 degrees of the arclength of the grinding disk, and
a chord portion defined by an absence of the second vertical segment around a balance of the arclength of the grinding disk, and
the inner shroud is rotatable relative to the outer shroud between a closed position, in which the chord portion of the inner shroud is covered by the outer shroud and an entirety of the arclength of the grinding disk is covered by a combination of the inner shroud and the outer shroud, and an open position, in which the chord portion of the inner shroud is not covered by the outer shroud, exposing a portion of the arclength of the grinding disk from the dust shroud assembly.

8. The grinding tool of claim 7, wherein:
the outer shroud includes an outer shroud magnetic element,
the inner shroud includes an inner shroud magnetic element, the inner shroud magnetic element and the outer shroud magnetic element being attracted to each other, and
magnetic coupling of the outer shroud magnetic element and the inner shroud magnetic element releasably retains the dust shroud assembly in at least one of the closed position or the open position.

9. The grinding tool of claim 8, wherein:
the outer shroud magnetic element is an outer shroud magnet, and
the inner shroud magnetic element is an inner shroud magnet.

10. The grinding tool of claim 8, wherein:
the outer shroud magnetic element is an outer shroud magnet, and
the inner shroud magnetic element includes a ferromagnetic metal.

11. The grinding tool of claim 8, wherein:
the outer shroud magnetic element is a ferromagnetic metal, and
the inner shroud magnetic element is an inner shroud magnet.

12. The grinding tool of claim 7, wherein:
the outer shroud includes a skirt circumferentially extending around more than 180 degrees of the arclength of the grinding disk, the skirt including a first outer shroud detent recess and a second outer shroud detent recess,
the inner shroud includes a shroud detent, and
when the inner shroud is positioned in the closed position, the shroud detent is received in the first outer shroud detent recess, and when the inner shroud is positioned in the open position, the shroud detent is received in the second outer shroud detent recess.

13. The grinding tool of claim 12, wherein the first outer shroud detent recess is provided in a first upstanding ear, wherein the second outer shroud detent recess is provided in a second upstanding ear, and wherein the first and second upstanding ears are positioned on an upper side of the outer shroud.

14. The grinding tool of claim 12, wherein the first and second outer shroud detent recesses are positioned in an outer periphery of the skirt.

15. The grinding tool of claim 1, further comprising a pommel handle and a mounting flange, the mounting flange positioned within the pommel handle and fastened to the pommel handle with fasteners, the mounting flange fixing the adjustment ring in a single axial position with respect to the pommel handle along the grinding disk rotational axis.

16. The grinding tool of claim 1, further comprising a pommel handle having a projection extending into a circumferential external groove of the adjustment ring to axially fix a position of the adjustment ring relative to the pommel handle.

17. The grinding tool of claim 16, wherein the pommel handle includes a recess housing a detent mechanism including a detent ball and a detent spring, wherein the detent spring biases the detent ball into one of the adjustment ring detent recesses positioned around the outside of the adjustment ring, and wherein rotating the adjustment ring about the adjustment ring axis selects a particular adjustment ring detent recess into which the detent ball is biased.

18. The grinding tool of claim 1, wherein:
the hub portion is an outer hub portion having inner axial protrusions,
the grinding tool includes a support member having a cylindrical inner bore supporting a bearing, the bearing supporting the output shaft,
the support member is secured to a lower side of a gearbox, the support member including an inner hub portion having outer axial protrusions, and
the inner hub portion is received within the outer hub portion such that the inner axial protrusions within the outer hub portion engage with the outer axial protrusions within the inner hub portion to define one or more predetermined relative rotational orientations about the grinding disk rotational axis at which the outer shroud is permitted to engage the support member.

19. The grinding tool of claim 1, the dust shroud assembly further including a dust extraction tube extending from the outer shroud,
wherein the outer shroud includes a first arcuate wall portion having a first horizontal segment extending radially outward from the hub portion relative to the grinding disk rotational axis, and a first vertical segment circumferentially extending around less than 180 degrees of an arclength of the grinding disk,
wherein the inner shroud includes:
a second arcuate wall portion having a second horizontal segment extending radially outward in a direction away from a center of the inner shroud relative to the grinding disk rotational axis, and a second vertical segment circumferentially extending around more than 180 degrees of the arclength of the grinding disk, and
a chord portion defined by an absence of the second vertical segment around a balance of the arclength of the grinding disk, and
wherein the inner shroud is rotatable relative to the outer shroud between a closed position, in which the chord portion of the inner shroud is covered by the outer shroud and an entirety of the arclength of the grinding disk is covered by a combination of the inner shroud and the outer shroud, and an open position, in which the chord portion of the inner shroud is not covered by the outer shroud, exposing a portion of the arclength of the grinding disk from the dust shroud assembly.

20. The grinding tool of claim 19, wherein the dust extraction tube extends from an upper side of the outer shroud and defines a dust extraction axis extending at a first nonzero acute angle relative to a grinding disk plane defined by a grinding surface of the grinding disk and measured in a direction perpendicular to the grinding disk plane, and wherein the dust extraction axis extends at a second nonzero acute angle relative to a motor rotational axis of the electric motor and measured in a direction parallel to the grinding disk plane.

21. The grinding tool of claim 19, wherein the hub portion includes an inner circumferential protrusion at a base of the hub portion, wherein the inner circumferential protrusion is interrupted by smooth portions that are flush with a majority of a radially inner surface of the hub portion, wherein the hub portion includes pairs of inner axial protrusions, and wherein each pair of inner axial protrusions is positioned above one of the smooth portions.

22. The grinding tool of claim 19, wherein the hub portion is an outer hub portion and includes inner axial protrusions, and wherein a support member is coupled to a gearbox and includes an inner hub portion including outer axial protrusions, the inner axial protrusions configured to engage the outer axial protrusions to define one or more predetermined relative rotational orientations about the grinding disk rotational axis at which the outer shroud is permitted to engage the support member.

23. The grinding tool of claim 19, wherein:
the first arcuate wall portion of the outer shroud includes a first upstanding ear and a second upstanding ear, the upstanding ears positioned on an upper side of the outer shroud, the first upstanding ear including a first outer shroud detent recess and the second upstanding ear including a second outer shroud detent recess,
the inner shroud includes a hand grip configured for rotating the inner shroud and a detent positioned in the hand grip, and
when the inner shroud is positioned in the closed position, the detent is received in the first outer shroud detent recess, and when the inner shroud is positioned in the open position, the detent is received in the second outer shroud detent recess.

24. The grinding tool of claim 19, wherein:
the first arcuate wall portion of the outer shroud includes a skirt, a first outer shroud detent recess, and a second outer shroud detent recess, the first and second outer shroud detent recesses positioned in an outer periphery of the skirt,
the inner shroud includes a hand grip configured for rotating the inner shroud and a detent positioned in the hand grip, and
when the inner shroud is positioned in the closed position, the detent is received in the first outer shroud detent recess, and when the inner shroud is positioned in the open position, the detent is received in the second outer shroud detent recess.

25. The grinding tool of claim 19, wherein the hub portion is an outer hub portion, wherein the inner shroud includes an upstanding inner hub portion at least partially configured as a cylinder defining an inner hub portion axis, the inner hub portion configured to fit within the outer hub portion to attach the outer shroud to the inner shroud, and wherein the inner hub portion includes a plurality of upstanding projections positioned about the inner hub portion axis, each upstanding projection including a hook oriented radially outwardly relative to the inner hub portion axis, the inner hub portion configured to fit within the outer hub portion to attach the outer shroud to the inner shroud.

26. The grinding tool of claim 25, wherein a gap between adjacent upstanding projections spans a first proportion of the arclength of the grinding disk, wherein at least one of the upstanding projections spans a second proportion of the arclength of the grinding disk, and wherein the first proportion of the arclength is approximately equal to the second proportion of the arclength.

27. The grinding tool of claim 25, wherein a gap between adjacent upstanding projections spans a first proportion of the arclength of the grinding disk, wherein at least one of the upstanding projections spans a second proportion of the arclength of the grinding disk, and wherein the first proportion of the arclength is within 30% of the second proportion of the arclength.

28. The grinding tool of claim 1, wherein the adjustment ring detent recesses are evenly spaced about a complete outer circumference of the adjustment ring.

29. The grinding tool of claim 1, further comprising a dust shroud latching assembly configured to selectively secure the inner shroud at a plurality of positions relative to the outer shroud, the dust shroud latching assembly including a magnet coupled to one of the outer shroud or the inner shroud and a magnetic element coupled to the other of the outer shroud or the inner shroud, wherein the magnet cooperates with the magnetic element to hold the inner shroud and the outer shroud in a first relative position until changed by the user.

30. The grinding tool of claim 29, wherein the magnetic element is a ferromagnetic mass.

31. The grinding tool of claim 29, wherein the magnet is a first magnet, and wherein the magnetic element is a second magnet.

32.-42. (canceled)
